(19) United States
(12) Patent Application Publication
(10) Pub. No.: US 2003/0133840 A1
(43) Pub. Date: Jul. 17, 2003

(54) Segmented area detector for biodrive and methods relating thereto

(76) Inventors: James Howard Coombs, Irvine, CA (US); Kevin Robert Mcintyre, Irvine, CA (US)

Correspondence Address: COUDERT BROTHERS LLP, 333 SOUTH HOPE STREET, 23RD FLOOR, LOS ANGELES, CA, 90071, US

(21) Appl. No.: 10/279,677

(22) Filed: Oct. 24, 2002

Related U.S. Application Data
(60) Provisional application No. 60/335,123, filed on Oct. 24, 2001.
(60) Provisional application No. 60/352,649, filed on Jan. 28, 2002.
(60) Provisional application No. 60/353,739, filed on Jan. 30, 2002.
(60) Provisional application No. 60/355,644, filed on Feb. 5, 2002.
(60) Provisional application No. 60/355,090, filed on Feb. 7, 2002.
(60) Provisional application No. 60/356,982, filed on Feb. 13, 2002.
(60) Provisional application No. 60/357,235, filed on Feb. 14, 2002.
(60) Provisional application No. 60/358,479, filed on Feb. 19, 2002.
(60) Provisional application No. 60/372,007, filed on Apr. 11, 2002.
(60) Provisional application No. 60/408,227, filed on Sep. 4, 2002.

(51) Int. Cl. G01N 21/00

(52) U.S. Cl. 422/82.05; 436/164; 436/165; 435/39

(57) ABSTRACT

According to one or more embodiments, the present invention is directed at many implementations of detectors utilized in bio-drives and in combination with a variety of different optical analysis discs or optical bio-discs. According to one embodiment of the present invention, the detector is a multi-segmented detector. According to another embodiment of the present invention, the detector is a radially long split detector. The detectors are segmented to implement noise-cancellation mechanism that enhances the overall signal-to-noise ratio. The detector embodiments produce clear and distinguishable signals that allow cell counting to be conducted efficiently in hardware. Another embodiment is a cost-efficient analyzer named a biological compact disc (BCD™) analyzer that comprises an optical disc drive and a controller into which is placed a field programmable gate array (FPGA) where all the digital logic is performed. The analyzer takes advantage of enhanced signals from segmented detector to analyze biological samples efficiently.

### CROSS-REFERENCE TO RELATED APPLICATIONS

The present application claims the benefit of priority from U.S. Provisional Patent Application entitled “Segmented Area Detector For Biodrive And Methods Relating Thereto”, Serial No. 60/335,123 filed on Oct. 24, 2001, U.S. Provisional Patent Application entitled “Segmented Area Detector For Biodrive And Methods Relating Thereto”, Serial No. 60/352,649 filed on Jan. 28, 2002, U.S. Provisional Patent Application entitled “Segmented Area Detector For Biodrive And Methods Relating Thereto”, Serial No. 60/353,739 filed on Jan. 30, 2002, U.S. Provisional Patent Application entitled “Segmented Area Detector For Biodrive And Methods Relating Thereto”, Serial No. 60/355,090 filed on Feb. 7, 2002, U.S. Provisional Patent Application entitled “Segmented Area Detector For Biodrive And Methods Relating Thereto”, Serial No. 60/357,235 filed on Feb. 14, 2002. All of the above referenced applications are herein incorporated by reference in their entirety.

### BACKGROUND OF THE INVENTION

1. Field of Invention

The present invention relates in general to bio-drives and, in particular to detectors used in bio-drives adapted to receive optical bio-discs. More specifically, but without restriction to the particular embodiments hereinafter described in accordance with the best mode of practice, this invention relates to segmented area detectors for bio-drives and methods relating thereto. The present invention is further directed to pattern recognition methods for the counting of cells on a bio-disc analyzed in a bio-drive employing the detectors of the present invention.

2. Discussion of the Related Art

Optical bio-drives have been implemented as cost-efficient and effective alternatives for conducting cell counting and biological sample assays. An example optical bio-drive configuration is shown in FIG. 1. Optical bio-disc 110, with fluidic channels housing biological samples is inserted into an optical disc drive 112. The optical features within optical disc drive 112 conduct biological assays on the samples housed within optical bio-disc 110. The optical mechanism of the optical disc drive 112 directs its laser beam at optical bio-disc 110 and uses a detector to detect reflected and/or scattered light. The detected light is converted to signal, which is converted to data that can be analyzed by computer 114. Monitor of display computer 114 displays the results of the assays.

The imaging of cells in liquid on or near to a partially reflecting surface with a scanning spot optical reader (such as optical bio-drive 112 or scanning optical microscope (SOM)) gives low contrast images. In these images, cells are sometimes difficult to recognize relative to the other surface structures. The primary reason for this is that cells have a refractive index very similar to the surrounding water or substrate, giving low reflection levels from the interfaces. This makes the definitive recognition and counting of cells difficult and increases the error rate.

Much effort has been concentrated on improving the mechanism by which assays are conducted in optical bio-drives. Prior art systems such as the one depicted in FIG. 1 encounter several difficulties. For example, cell counting accuracy is affected by noisy images generated from the quad detector in the optical disc drive 112 because of low signal-to-noise ratios. The usage of a top detector, as supposed to the more conventional quad detector, does improve the signal-to-noise ratio when coupled with a circuit board. In some instances, the signal-to-noise ratio improves by more than a factor of 10.

Sometimes, large amount of computer memory is needed because the counting process needs to analyze large data files from entire assay runs. The large data files also slow down the entire assay process. Improving the efficiency of computer resource usage and the speed of processing is a challenge.

Another challenge in improving the bio-drive is cell recognition. Cell recognition is difficult as biological samples often comprise several elements such as white blood cells, red blood cells, lymphocytes, etc. In analyzing these mixed bio samples, thresholds need to be generated so that only specific types of cells are counted.

Since many applications require accurate cell counting, the problem needs to be overcome in a reliable device. A method is needed for uniquely distinguishing cells from background signal noise. In some instances, it is also advantageous to have an efficient real-time cell recognition method.

### SUMMARY OF THE INVENTION

The present invention is directed at many implementations of detectors utilized in optical disc drives and in combination with a variety of different optical analysis discs or optical bio-discs. According to one embodiment, the present invention is directed to pattern and cell recognition for the counting of cells in an optical bio-drive. According to one embodiment of the present invention, the detector is a multi-element detector. According to another embodiment of the present invention, the detector is a radially long split detector. Other embodiments include detectors that are oriented radially and tangentially, in relation to the disc. The detectors are segmented to implement noise-cancellation mechanism that enhances the overall signal-to-noise ratio. The detector embodiments produce clear and distinguishable signals that allow cell counting to be conducted efficiently in hardware.

Another embodiment of the present invention is an optical bio-disc analyzer named biological compact disc (BCD™) analyzer. The analyzer takes advantage of the detector embodiments in the present invention to analyzer biological sample on bio-discs. The analyzer is comprised of a controller into which is placed a field programmable gate array (FPGA) where all the digital logic is performed.

The hardware architecture of the controller comprises the following components: detector format, preamplifier design, DC level control, detector channel combining, gain control, cell counting circuitry, Analog-to-Digital conversion, sample area trigger detection and control, IDE interface for drive control, Ethernet interface for the user to have control and status, digital logic device, micro controller.

The basic architecture of the analyzer provides for a top detector that provides a large improvement in signal-to-noise ratio over HF signal derived from a bottom detector. Furthermore there is a pre-amplifier circuit near detector to provide for a higher signal-to-noise ratio than routing the detector output any significant distance to reach the pre-amplifier. A DC level control is included to provide a calibrated output. This is required for making accurate optical density measurements. Also included is a gain control that provides consistent voltage levels for cell detection and to optimize the resolution of the optical density measurements.

In addition, a highly accurate sample area trigger detection system is included in the analyzer. The trigger is based on a signal that indicates the position of the sample area relative to the detector. This signal is required to analyze the detector output signal at the appropriate time. It must be accurate to less than one micron for accurate correlation of data from one revolution to the next unless complicated de-staggering is performed. There is also a user interface that allows the user to control the analyzer and receives test results and other useful information related to the test.

Co-ordination of among the optical disc drive, the sample analyzing electronics and the user interface is also provided. The disc must rotate at the correct speed, the laser position must be controlled, the processing of the detector signals must be done, and the user must be able to control the system and receive results and status information.

One embodiment the present invention is directed at pattern and cell recognition for the counting of cells in an optical bio-drive. The present invention combines circuitry component that is coupled to the segmented detector embodiments. A detector signal analyzer, in one embodiment, is implemented in a field programmable gate array (FPGA) with the controller. The FPGA is configured to include cell pattern recognition algorithms to aid the analysis of samples of bio-discs. Memory, I/O Bus interfaces and other computing components are part of the circuitry component that is coupled to the segmented detector.

An object of the present invention is to provide accurate and efficient cell counting that does not require a large amount of microprocessor power and memory storage space. Embodiments of the present invention extract enhanced signals from detectors and employ user-adjustable cell-counting and pattern-recognition algorithms on the extracted signals to produce results in real-time.

The implementation of the long-split detector coupled to the hardware cell detecting algorithms removes the necessity for utilizing an expensive Pentium-class high power microprocessor coupled with a high-speed analog-to-digital converter. This enables a new and considerably cheaper architecture based on a simple 8-bit microcontroller and a digital logic device. Many of the complex tasks have been done traditionally in software by storing large files and then processing them once they have been collected. Hardware is capable of doing these tasks at not only a much greater speed, but without the need for an expensive processor. In the present invention, a simple 8-bit microcontroller 60 is capable of controlling the optical bio-disc analyzer system. It need only send a few simple controls to the optical disc drive, setup the digital and analog circuitry that processes the detector signals, and report the results and give control to the user.

The present invention hereby incorporates by reference U.S. Provisional Patent Application, entitled “Bio-Disc And Bio-Drive Analyzer System Including Methods Relating Thereto”, Serial No. 60/372,007, filed on Apr. 11, 2002 in its entirety. This provisional patent relates in general to optical bio-discs and bio-drives and, in particular, to integrated analyzer systems adapted to perform diagnostic assays on optical bio-discs. More specifically, the invention relates to hardware architecture of the analyzer system including hardware implementation of cell-counting.

The present invention is directed to bio-discs, bio-drives, and in particular to hardware architecture of a bio-analyzer system including hardware implementations of cell counting methods. This invention or different aspects thereof may be readily implemented in, adapted to, or employed in combination with the discs, assays, and systems disclosed in the following commonly assigned and co-pending patent applications: U.S. patent application Ser. No. 09/378,878 entitled “Methods and Apparatus for Analyzing Operational and Non-operational Data Acquired from Optical Discs” filed Aug. 23, 1999; U.S. Provisional Patent Application Serial No. 60/150,288 entitled “Methods and Apparatus for Optical Disc Data Acquisition Using Physical Synchronization Markers” filed Aug. 23, 1999; U.S. patent application Ser. No. 09/421,870 entitled “Trackable Optical Discs with Concurrently Readable Analyte Material” filed Oct. 26, 1999; U.S. patent application Ser. No. 09/643,106 entitled “Methods and Apparatus for Optical Disc Data Acquisition Using Physical Synchronization Markers” filed Aug. 21, 2000; U.S. patent application Ser. No. 09/999,274 entitled “Optical Bio-discs with Reflective Layers” filed on Nov. 15, 2001; U.S. patent application Ser. No. 09/988,728 entitled “Methods And Apparatus For Detecting And Quantifying Lymphocytes With Optical Biodiscs” filed on Nov. 20, 2001; U.S. patent application Ser. No. 09/988,850 entitled “Methods and Apparatus for Blood Typing with Optical Bio-discs” filed on Nov. 19, 2001; U.S. patent application Ser. No. 09/989,684 entitled “Apparatus and Methods for Separating Agglutinants and Disperse Particles” filed Nov. 20, 2001; U.S. patent application Ser. No. 09/997,741 entitled “Dual Bead Assays Including Optical Biodiscs and Methods Relating Thereto” filed Nov. 27, 2001; U.S. patent application Ser. No. 09/997,895 entitled “Apparatus and Methods for Separating Components of Particulate Suspension” filed Nov. 30, 2001; U.S. patent application Ser. No. 10/005,313 entitled “Optical Discs for Measuring Analytes” filed Dec. 7, 2001; U.S. patent application Ser. No. 10/006,371 entitled “Methods for Detecting Analytes Using Optical Discs and Optical Disc Readers” filed Dec. 10, 2001; U.S. patent application Ser. No. 10/006,620 entitled “Multiple Data Layer Optical Discs for Detecting Analytes” filed Dec. 1 0, 2001; U.S. patent application Ser. No. 10/006,619 entitled “Optical Disc Assemblies for Performing Assays” filed Dec. 10, 2001; U.S. patent application Ser. No. 10/020,140 entitled “Detection System For Disk-Based Laboratory And Improved Optical Bio-Disc Including Same” filed Dec. 14, 2001; U.S. patent application Ser. No. 10/035,836 entitled “Surface Assembly For Immobilizing DNA Capture Probes And Bead-Based Assay Including Optical Bio-Discs And Methods Relating Thereto” filed Dec. 21, 2001; U.S. patent application Ser. No. 10/038,297 entitled “Dual Bead Assays Including Covalent Linkages For Improved Specificity And Related Optical Analysis Discs” filed Jan. 4, 2002; U.S. patent application Ser. No. 10/043,688 entitled “Optical Disc Analysis System Including Related Methods For Biological and Medical Imaging” filed Jan. 10, 2002; and U.S. Provisional Application Serial No. 60/348,767 entitled “Optical Disc Analysis System Including Related Signal Processing Methods and Software” filed Jan. 14, 2002. All of these applications are herein incorporated by reference in their entireties. They thus provide background and related disclosure as support hereof as if fully repeated herein.

### BRIEF DESCRIPTION OF THE DRAWINGS

Further objects of the present invention together with additional features contributing thereto and advantages accruing there from will be apparent from the following description of the preferred embodiments of the invention which are shown in the accompanying drawing figures with like reference numerals indicating like components throughout, wherein:

FIG. 1 is a pictorial representation of a bio-disc system;

FIG. 2 is an illustration of the architecture of the present invention;

FIG. 3 is an exploded perspective view of a reflective bio-disc as utilized in conjunction with the present invention;

FIG. 4 is a top plan view of the disc shown in FIG. 3;

FIG. 5 is a perspective view of the disc illustrated in FIG. 3 with cut-away sections showing the different layers of the disc;

FIG. 6 is an exploded perspective view of a transmissive bio-disc as employed in conjunction with the present invention;

FIG. 7 is a perspective view representing the disc shown in FIG. 6 with a cut-away section illustrating the functional aspects of a semi-reflective layer of the disc;

FIG. 8 is a graphical representation showing the relationship between Au layer thickness and transmission/reflection of incident laser light;

FIG. 9 is a top plan view of the disc shown in FIG. 6;

FIG. 10 is a perspective view of the disc illustrated in FIG. 6 with cut-away sections showing the different layers of the disc including the type of semi-reflective layer shown in FIG. 7;

FIG. 11 is an exploded perspective view of a peripheral-circumferential reservoir disc (hereinafter “reservoir disc”) as employed in conjunction with the present invention;

FIGS. 12A, 12B, and 12C are perspective views of three different embodiments of the substrate element of the reservoir disc according to the present invention;

FIG. 13 is a perspective view of a pair of concentric peripheral-circumferential reservoirs as implemented in the cap member of a reservoir disc according another aspect of the present invention;

FIG. 14 is a top plan view of a reservoir disc assembly in the transmissive format utilizing the substrate member of FIG. 12A including absorber pads positioned within the outer reservoir;

FIG. 15 is a perspective view of the disc illustrated in FIG. 14 with cut-away sections showing the different layers of the disc including the type of semi-reflective layer shown in FIG. 7;

FIG. 16 is a view similar to FIG. 15 with cut-away sections showing different layers of an alternate embodiment of a reservoir disc utilizing discrete capture zones rather than an active layer;

FIG. 17 is a perspective and block diagram representation illustrating an optical bio-disc system in detail;

FIG. 18 is a plan view of a disc showing target zones and a hardware trigger;

FIG. 19A is a partial cross sectional view taken perpendicular to a radius of the reflective optical bio-disc illustrated in FIGS. 3, 4, and 5 or the reservoir discs in FIGS. 10-14 when implemented in a reflective format;

FIG. 19B is a partial cross sectional view taken perpendicular to a radius of a bio-disc in the reflective format showing capture antibodies attached within a flow channel of the disc;

FIG. 20A is a partial cross sectional view taken perpendicular to a radius of the transmissive optical bio-disc illustrated in FIGS. 6, 9, and 10 or the reservoir discs in FIGS. 11-15 when implemented in a transmissive format;

FIG. 20B is a partial cross sectional view taken perpendicular to a radius of a bio-disc in the transmissive format showing capture antibodies attached within a flow channel of the disc;

FIG. 21 is a partial longitudinal cross sectional view representing the reflective format bio-discs of the present invention illustrating a wobble groove formed therein;

FIG. 22 is a partial longitudinal cross sectional view representing the transmissive format bio-discs of the present invention illustrating a wobble groove formed therein and a top detector;

FIG. 23 is a view similar to FIG. 19A showing the entire thickness of the reflective disc and the initial refractive property thereof;

FIG. 24 is a view similar to FIG. 20A showing the entire thickness of the transmissive disc and the initial refractive property thereof;

FIG. 25 is a top view of a circuit board including a triggering detection assembly according to another aspect of the present invention;

FIG. 26 is an electrical schematic of the triggering circuit shown in FIG. 25;

FIG. 27 is a part pictorial, part block diagram showing a disc and a reading system as implemented according to certain aspects of the present invention;

FIG. 28A shows the optical path of the incident beam without a sphere;

FIG. 28B illustrates the optical path of the incident beam focused by a sphere;

FIG. 28C is a pictorial depiction of the optical path of the incident beam deflected to the right by a sphere;

FIG. 28D illustrates the optical path of the incident beam deflected to the left by a sphere;

FIG. 28E shows the comparison of optical paths of the incident beam with and without refraction by a sphere;

FIG. 28F is an up close view of an optical path of the incident beam deflected by a sphere;

FIG. 29A shows the image of a sphere detected by a small square shaped detector;

FIG. 29B shows the image of a sphere detected by a long detector;

FIG. 30A illustrates an example quad detector;

FIG. 30B shows the image of a sphere detected by the quad detector shown in FIG. 30A;

FIG. 30C is a pictorial depiction of the resultant push-pull voltage graph of the sphere detected by the quad detector shown in FIG. 30A;

FIG. 30D shows other variant voltage graphs of the sphere detected by the quad detector shown in FIG. 30A;

FIG. 31A illustrates an example detector configuration with two long detectors according to an embodiment of the present invention;

FIG. 31B is a pictorial depiction of the image of sphere detected by the right detector in FIG. 31A;

FIG. 31C shows the image of sphere detected by the left detector in FIG. 31A;

FIG. 31D illustrates the resultant voltage graph of the sphere detected by the detectors in FIG. 31A;

FIG. 32A shows an example detector configuration with three long detectors (a wide center detector with two side detectors) according to an embodiment of the present invention;

FIG. 32B illustrates an example detector configuration with three long detectors (a narrow center detector with two side detectors) according to an embodiment of the present invention;

FIG. 32C shows an example detector configuration with four long detectors (two center detectors with two side detectors) according to an embodiment of the present invention;

FIG. 32D shows an example detector configuration with five long detectors (three center detectors with two side detectors) according to an embodiment of the present invention;

FIG. 33A illustrates an example detector configuration with five segments oriented in the radial direction according to an embodiment of the present invention;

FIG. 33B illustrates an example detector configuration with four segments oriented in the diagonal direction according to an embodiment of the present invention;

FIG. 33C shows the image detected by the four detector segments of the detector shown in FIG. 33B;

FIG. 34 is an illustration of a multi-element detector according to one embodiment of the present invention.

FIG. 35A is a top view of a bi-segmented (split) detector;

FIG. 35B is a 3-D view of a bi-segmented (split) detector;

FIG. 35C is resultant voltage plot of the signal detected by the bi-segmented detector in FIGS. 35A and 35B;

FIG. 36A is a bi-segmented detector where the detector width is less than the numerical aperture of the lens;

FIG. 36B is resultant voltage plot of the signal detected by the bi-segmented detector in FIG. 36A;

FIG. 37A shows an example detector configuration with three long detectors (a center detector with two side detectors) according to an embodiment of the present invention;

FIG. 37B shows an example detector configuration with four segments making up two long detectors according to an embodiment of the present invention;

FIG. 38 is an illustration of a split detector according to one embodiment of the present invention;

FIG. 39A illustrates images of white blood cells detected by the present invention;

FIG. 39B is an image of 10 micron beads, which are spherical polystyrene detected by the present invention;

FIG. 40 illustrates images of red blood cells detected by the present invention;

FIG. 41 illustrates images of red blood cells detected by the present invention and a plot of intensity across one horizontal line;

FIG. 42 illustrates images of white blood cells and platelets detected by the present invention and intensity plots over several horizontal lines;

FIG. 43A illustrates an asymmetric detector according to an embodiment of the present invention;

FIG. 43B is a voltage plot that shows a comparison between the resultant signals detected by the asymmetric detector and the symmetric detector;

FIG. 43C shows the three different types of offset that can be implemented in the asymmetric detector;

FIG. 43D shows the image of a sphere without asymmetric detector.

FIG. 43E illustrates the images of a sphere with the three different types of offset shown in FIG. 43C;

FIG. 44 is an illustration of a BCD™ analyzer;

FIG. 45 is a block diagram of the BCD™ analyzer, according to one embodiment of the present invention;

FIG. 46 is an illustration of a BCD™ analyzer controller;

FIG. 47A is a block diagram of the controller in FIG. 46, according to one embodiment of the present invention;

FIG. 47B is a block diagram showing how the controller is implemented with the rest of the optical components of an optical biodrive according to one embodiment of the present invention;

FIG. 47C is a schematic of the controller showing how the controller is implemented with the rest of the optical components of an optical biodrive according to one embodiment of the present invention;

FIG. 48 is an illustration of a disc used in the present invention;

FIG. 49A is a pictorial depiction of a process of converting detected analog signals to pulses to a cell count;

FIG. 49B shows another process of converting detected analog signals to pulses to a cell count;

FIG. 50A shows the angles of deflection of the incident light entering a sphere;

FIG. 50B is a pictorial depiction of how the usage of slots can filter different deflected rays of incident beam;

FIG. 50C shows the detected image on a detector without the use of slots shown in FIG. 50B;

FIG. 50D shows the detected image on a detector with the use of slots shown in FIG. 50B;

FIG. 51A is a cell image and its accompanying S-curve voltage plot and derived pulse trains;

FIG. 51B shows the optical path of the incident beam is deflected at seven points in time during the detection;

FIG. 52A illustrates a pulse train graph according to the timing information seen in FIG. 51A;

FIG. 52B illustrates a state machine that detects valid S-curves based on timing information seen in FIG. 51A;

FIG. 53 illustrates a grid comprised of 1's and 0s, which is an example S-curve event that can be stored in RAM based on the state machine of FIG. 52B above;

FIG. 54 illustrates a track-to-track correlation matrix that operates on the grid of FIG. 53 during the non-sampling time of each revolution;

FIG. 55A is a resultant voltage plot pointing out two S-curve characteristics;

FIG. 55B is an example scatter plot showing the clustering of different cell types in relation the two S-curve characteristics shown in FIG. 55A;

FIG. 56A illustrates cell images captured using the present invention and a given set of threshold values;

FIG. 56B illustrates the location of S-curves recognized during the cell image capture seen in FIG. 56A using the present invention and a given set of threshold values; and

FIG. 56C illustrates the location of cells recognized through correlation matrix processing of the S-curves recognized in FIG. 56B using the present invention and a given matrix size.

### DETAILED DESCRIPTION OF THE INVENTION

The present invention relates in general to optical bio-drives and, in particular to detectors used in optical bio-drives adapted to receive optical bio-discs. More specifically, but without restriction to the particular embodiments hereinafter described in accordance with the best mode of practice, this invention relates to segmented area detectors for bio-drives and methods relating thereto. The present invention is further directed to pattern recognition methods for the counting of cells or other investigational features on a bio-disc analyzed in a bio-drive employing the detectors of the present invention.

Analyzer Unit

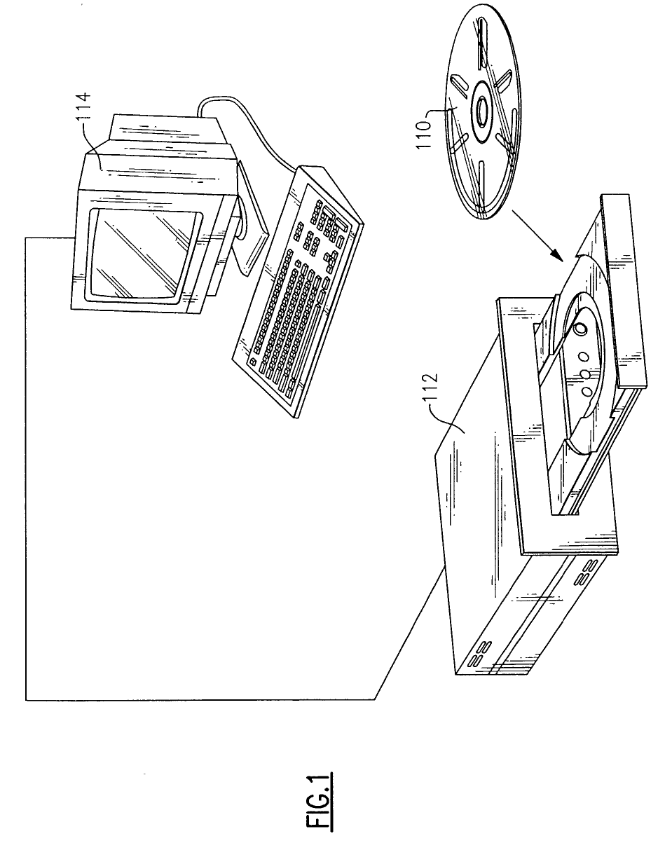

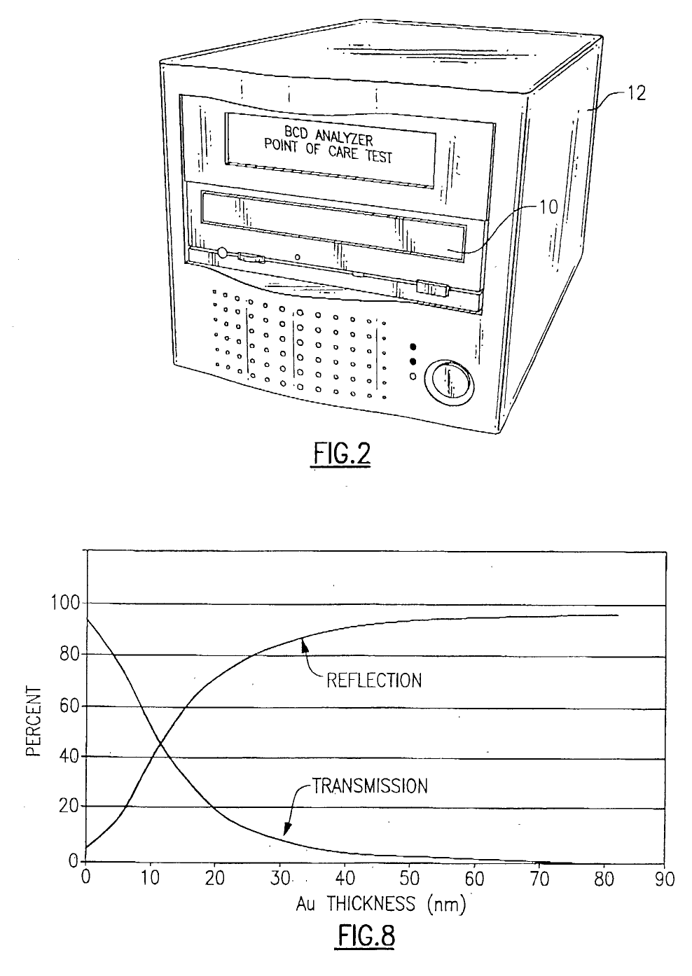

FIG. 2 is an illustration of an embodiment of the present invention. Analyzer 12 is the resulting architecture of one configuration of the present invention. Compared to prior art embodiment such as that shown in FIG. 1, analyzer 12 combines computing and processing component with an optical disc drive into a single unit. One skilled in the art will appreciate that FIG. 2 is but just one of the many different configurations possible of the present invention. According to this configuration, analyzer 12 may have a compact PC compatible system comprising of, for example, a 300 MHz processor, 128 MB of RAM, a PC/104 analog to digital (A/D) converter, and a VxWorks® operating system. A simple PC board with these components could further hold a detector and amplifier circuitry needed for extracting signals from an optical bio-disc in optical disc drive 10.

Optical Bio-Discs

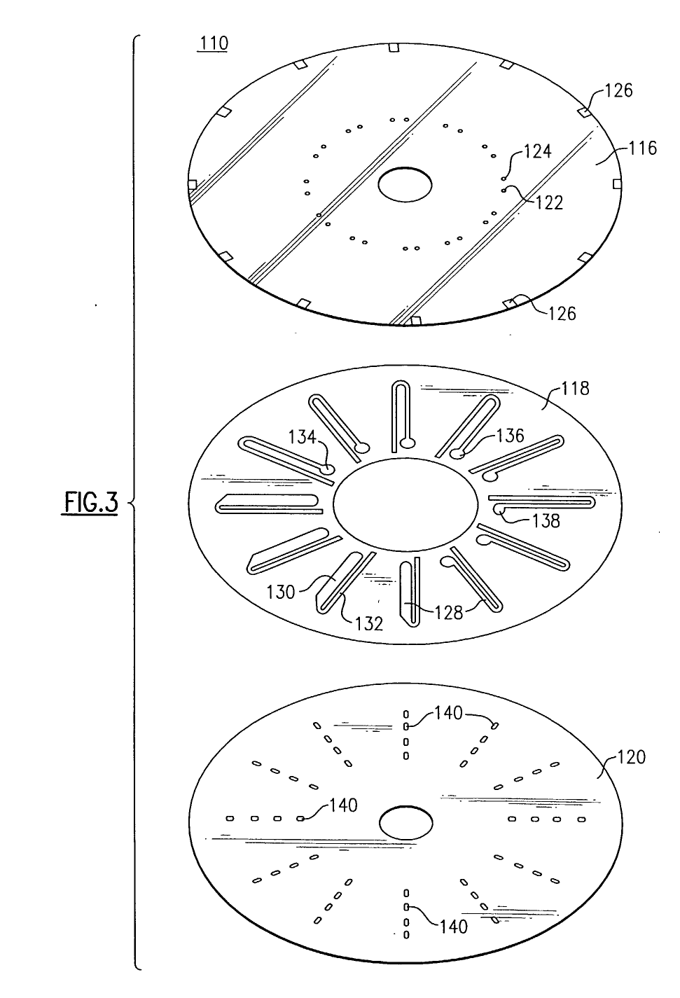

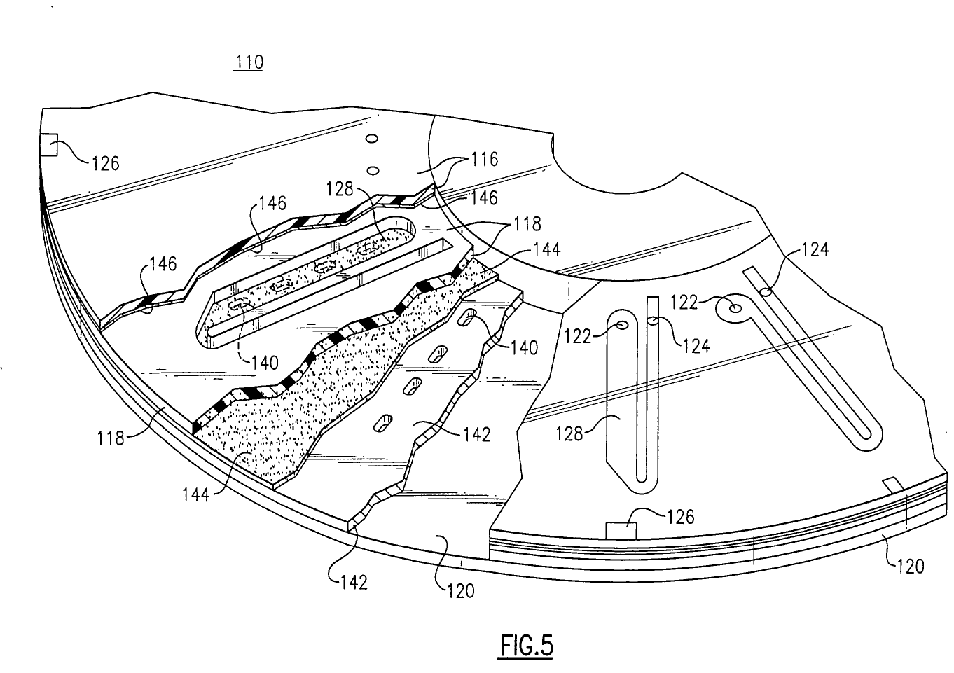

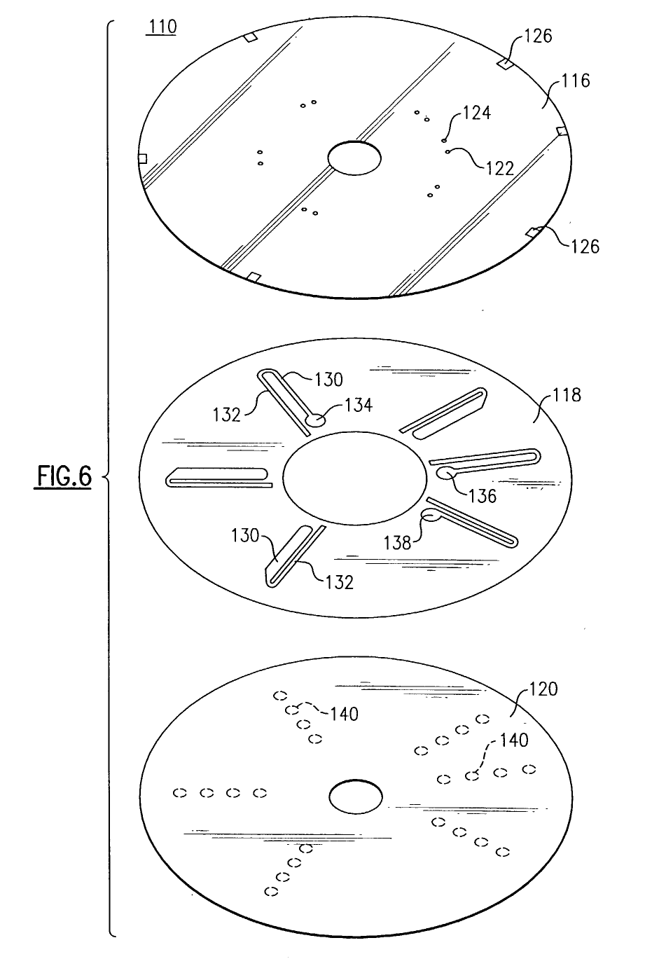

Embodiments of the present invention are designed to accept a wide variety of optical bio-discs. FIGS. 3 to 16 show the various example types of optical bio-discs that can be employed in performing biological analysis in the present invention. Briefly, FIGS. 3 to 5 are directed at showing the components of the reflective embodiment of optical bio-discs of the present invention. FIGS. 6 to 10 are directed at showing the components of the transmissive reflective embodiment of optical bio-discs of the present invention, as well as how the reflective and transmissive embodiments compare. Finally, FIGS. 11 to 16 are included to show the components of the peripheral-circumferential reservoir embodiment of the optical bio-disc.

Optical Bio-Discs: Reflective Embodiment

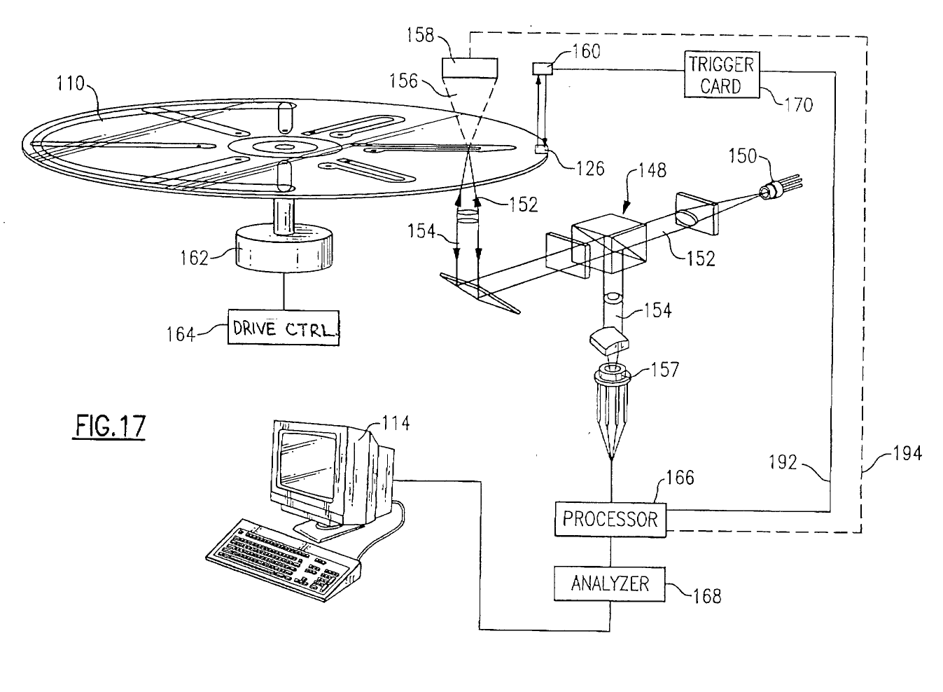

FIG. 3 is an exploded perspective view of the principal structural elements of the optical bio-disc 110. According to one embodiment of the present invention, the optical bio-disc is a reflective optical bio-disc (hereinafter “reflective disc” or “disc in reflective format”). The principal structural elements include a cap portion 116, an adhesive member or channel layer 118, and a substrate 120. The cap portion 116 includes one or more inlet ports 122 and one or more vent ports 124. The cap portion 116 may be formed from polycarbonate and is preferably coated with a reflective surface 146 (as better illustrated in FIG. 5) on the bottom thereof as viewed from the perspective of FIG. 3. In the preferred embodiment, trigger marks or markings 126 are included on the surface of the reflective layer. Trigger markings 126 may include a clear window in all three layers of the bio-disc, an opaque area, or a reflective or semi-reflective area encoded with information that sends data to a processor 166, as shown in FIG. 17, that in turn interacts with the operative functions of the interrogation or incident beam 152 in FIG. 17.

The second element shown in FIG. 3 is an adhesive member 118 having fluidic circuits 128 or U-channels formed therein. The fluidic circuits 128 are formed by stamping or cutting the membrane to remove the plastic film and form the shapes as indicated. Each of the fluidic circuits 128 includes a flow channel 130 and a return channel 132. Some of the fluidic circuits 128 illustrated in FIG. 3 include a mixing chamber 134. Two different types of mixing chambers 134 are illustrated. The first is a symmetric mixing chamber 136 that is symmetrically formed relative to the flow channel 130. The second is an off-set mixing chamber 138. The off-set mixing chamber 138 is formed to one side of the flow channel 130 as indicated.

The third element illustrated in FIG. 3 is a substrate 120 including target or capture zones 140. The substrate 120 is preferably made of polycarbonate and has a reflective metal layer 142 deposited on the top thereof as also illustrated in FIG. 5. The target zones 140 are formed by removing the reflective layer 142 in the indicated shape or alternatively in any desired shape. Alternatively, the target zone 140 may be formed by a masking technique that includes masking the target zone 140 area before applying the reflective layer 142. The reflective layer 142 may be formed from a metal such as aluminum, gold, silver, nickel, and reflective metal alloys.

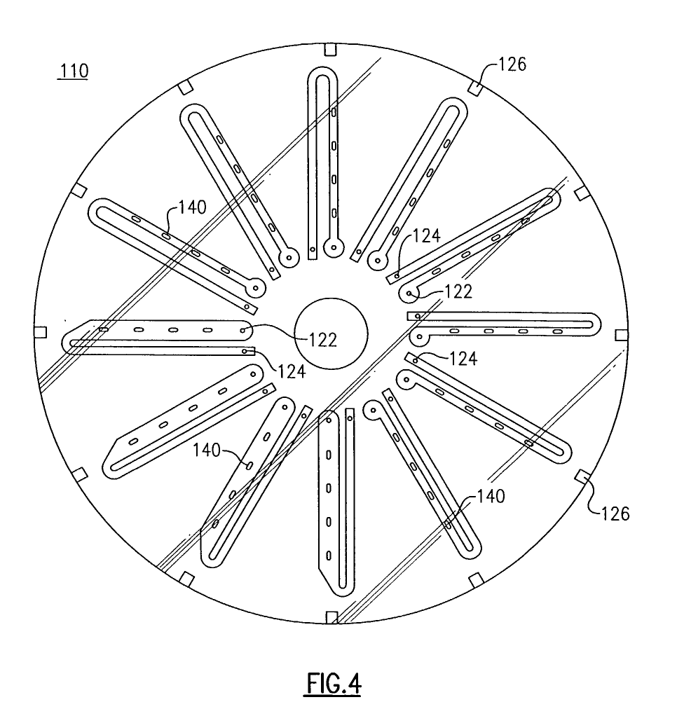

FIG. 4 is a top plan view of the optical bio-disc 110 illustrated in FIG. 3 with the reflective layer 142 on the cap portion 116 shown as transparent to reveal the fluidic circuits 128, the target zones 140, and trigger markings 126 situated within the disc.

FIG. 5 is an enlarged perspective view of the reflective zone type optical bio-disc 110 according to one embodiment of the present invention. This view includes a portion of the various layers thereof, cut away to illustrate a partial sectional view of each principal layer, substrate, coating, or membrane. FIG. 5 shows the substrate 120 that is coated with the reflective layer 142. An active layer 144 may be applied over the reflective layer 142. In the preferred embodiment, the active layer 144 may be formed from polystyrene. Alternatively, polycarbonate, gold, activated glass, modified glass, or modified polystyrene, for example, polystyrene-co-maleic anhydride, may be used. The active layer 144 may also be preferably formed through derivatization of the reflective layer 142 with self assembling monolayers such as, for example, dative binding of functionally active mercapto compounds on gold and binding of functionalized silicone compounds on aluminum. In addition hydrogels can be used. Alternatively, as illustrated in this embodiment, the plastic adhesive member 118 is applied over the active layer 144. If the active layer is not present, the adhesive member 118 is applied directly to the reflective metal layer 142. The exposed section of the plastic adhesive member 118 illustrates the cut out or stamped U-shaped form that creates the fluidic circuits 128. The final principal structural layer in this reflective zone embodiment of the present bio-disc is the cap portion 116. The cap portion 116 includes the reflective surface 146 on the bottom thereof. The reflective surface 146 may be made from a metal such as aluminum or gold.

Optical Bio-Discs: Transmissive Embodiment

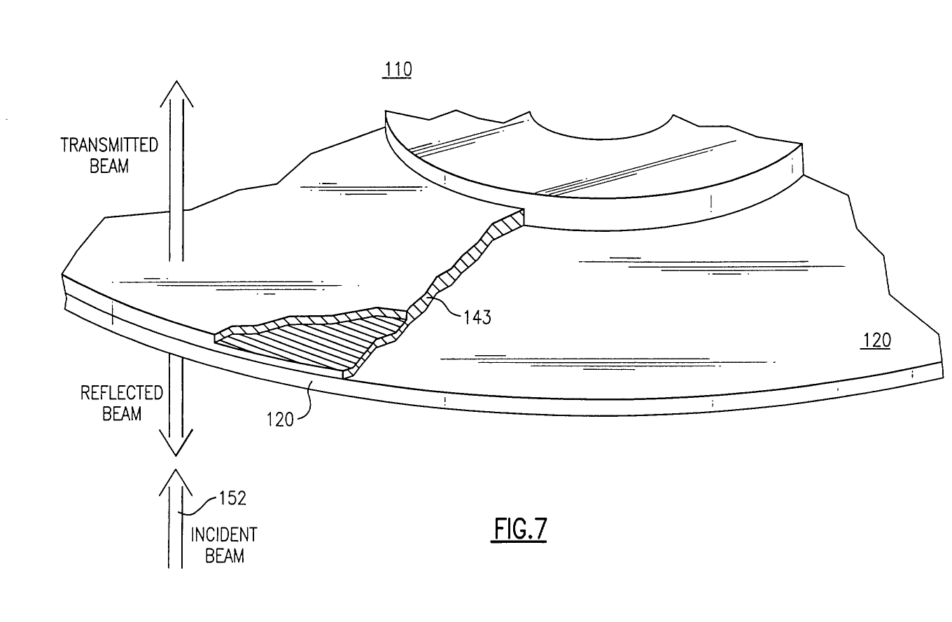

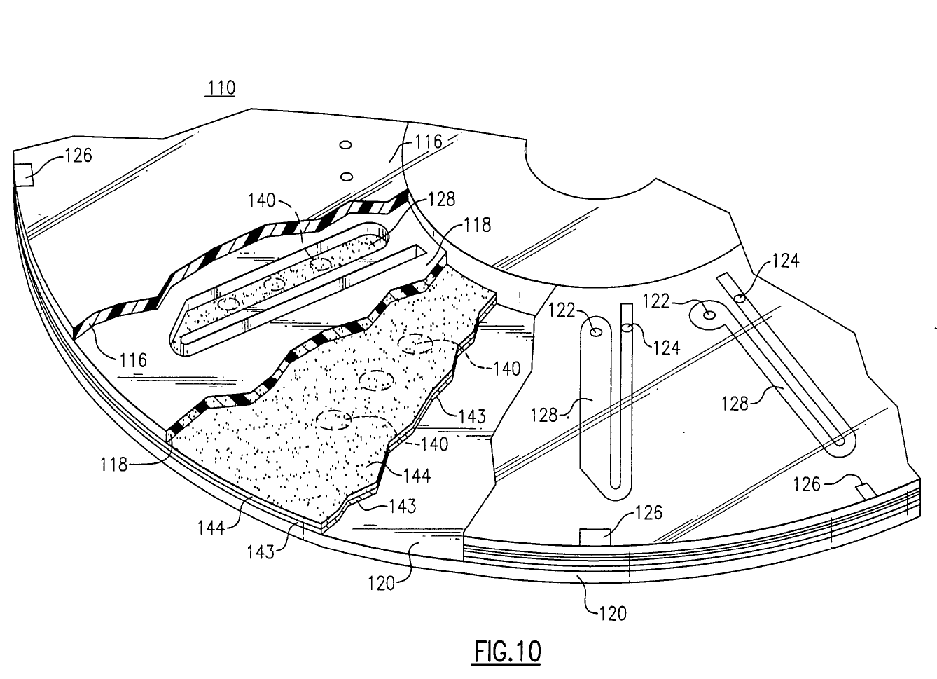

FIG. 6 is an exploded perspective view of the principal structural elements of an optical bio-disc 110. According to another embodiment of the present invention, the optical bio-disc is a transmissive type of optical bio-disc. The principal structural elements of the transmissive type of optical bio-disc 110 similarly include the cap portion 116, the adhesive member 118, and the substrate 120 layer. The cap portion 116 includes one or more inlet ports 122 and one or more vent ports 124. The cap portion 116 may be formed from a polycarbonate layer. Optional trigger markings 126 may be included on the surface of a thin semi-reflective metal layer 142, as best illustrated in FIGS. 7 and 10. Trigger markings 126 may include a clear window in all three layers of the bio-disc, an opaque area, or a reflective or semi-reflective area encoded with information that sends data to the processor 166, FIG. 17, which in turn interacts with the operative functions of the interrogation beam 152 in FIG. 17.

The second element shown in FIG. 6 is the adhesive member or channel layer 118 having fluidic circuits 128 or U-channels formed therein. The fluidic circuits 128 are formed by stamping or cutting the membrane to remove plastic film and form the shapes as indicated. Each of the fluidic circuits 128 includes the flow channel 130 and the return channel 132. Some of the fluidic circuits 128 illustrated in FIG. 6 include the mixing chamber 134. Two different types of mixing chambers 134 are illustrated. The first is the symmetric mixing chamber 136 that is symmetrically formed relative to the flow channel 130. The second is the off-set mixing chamber 138. The off-set mixing chamber 138 is formed to one side of the flow channel 130 as indicated.

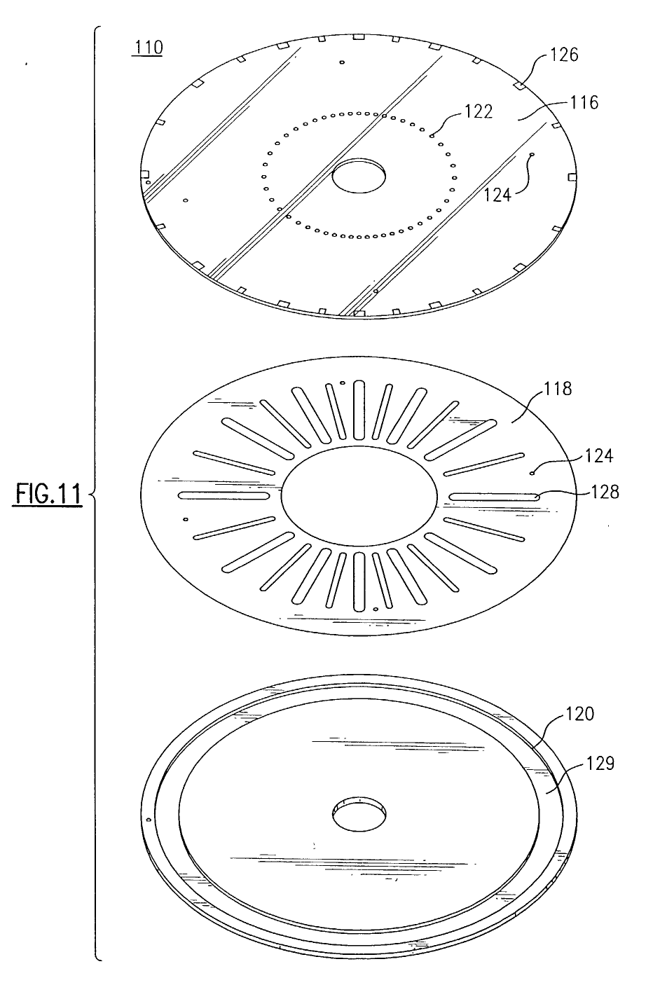

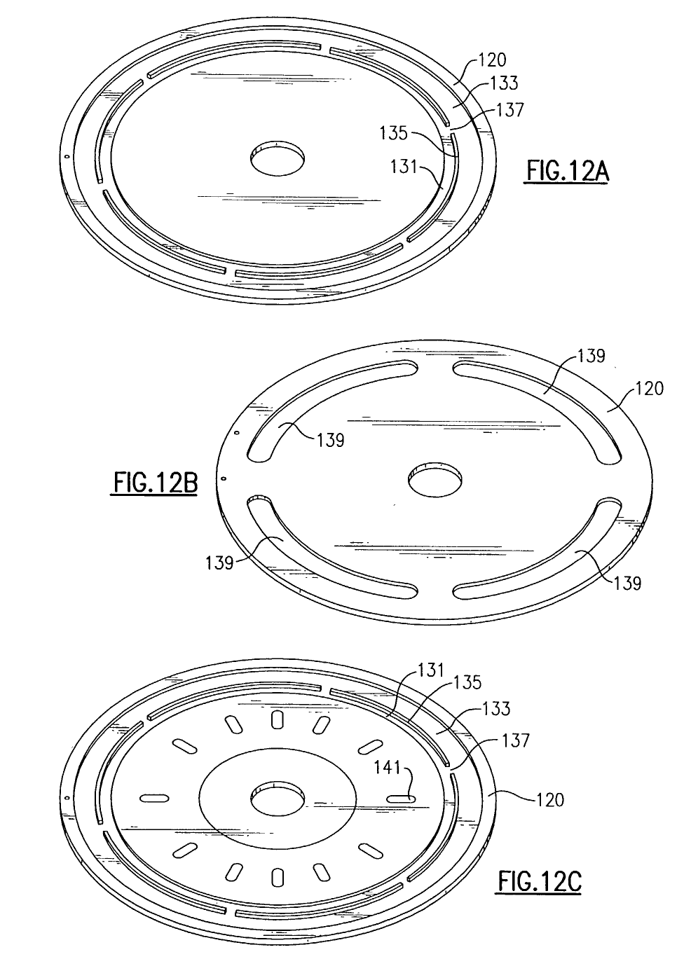

The third element illustrated in FIG. 6 is the substrate 120 which may include the target or capture zones 140. The substrate 120 is preferably made of polycarbonate and has the thin semi-reflective metal layer 143 deposited on the top thereof in FIG. 7. The semi-reflective layer 143 associated with the substrate 120 of the disc 110 illustrated in FIGS. 6 and 7 is significantly thinner than the reflective layer 142 on the substrate 120 of the reflective disc 110 illustrated in FIGS. 3, 4 and 5. The thinner semi-reflective layer 143 allows for some transmission of the interrogation beam 152 through the structural layers of the transmissive disc as shown in FIG. 12. The thin semi-reflective layer 143 may be formed from a metal such as aluminum or gold.

FIG. 7 is an enlarged perspective view of the substrate 120 and semi-reflective layer 143 of the transmissive embodiment of the optical bio-disc 110 illustrated in FIG. 6. The thin semi-reflective layer 143 may be made from a metal such as aluminum or gold. In the preferred embodiment, the thin semi-reflective layer 143 of the transmissive disc illustrated in FIGS. 6 and 7 is approximately 100-300 Å thick and does not exceed 400 Å. This thinner semi-reflective layer 143 allows a portion of the incident or interrogation beam 152 to penetrate and pass through the semi-reflective layer 143 to be detected by top detectors 158 (FIG. 17), while some of the light is reflected or returned back along the incident path. As indicated below, Table 1 presents the reflective and transmissive characteristics of a gold film relative to the thickness of the film. The gold film layer is fully reflective at a thickness greater than 800 Å. While the threshold density for transmission of light through the gold film is approximately 400 Å.

TABLE 1
Au film Reflection and Transmission (Absolute Values)

| Thickness | Thickness | | |
|---|---|---|---|
| (Angstroms) | (nm) | Reflectance | Transmittance |
| 0 | 0 | 0.0505 | 0.9495 |
| 50 | 5 | 0.1683 | 0.7709 |
| 100 | 10 | 0.3981 | 0.5169 |
| 150 | 15 | 0.5873 | 0.3264 |
| 200 | 20 | 0.7142 | 0.2057 |
| 250 | 25 | 0.7959 | 0.1314 |
| 300 | 30 | 0.8488 | 0.0851 |
| 350 | 35 | 0.8836 | 0.0557 |
| 400 | 40 | 0.9067 | 0.0368 |
| 450 | 45 | 0.9222 | 0.0244 |
| 500 | 50 | 0.9328 | 0.0163 |
| 550 | 55 | 0.9399 | 0.0109 |
| 600 | 60 | 0.9448 | 0.0073 |
| 650 | 65 | 0.9482 | 0.0049 |
| 700 | 70 | 0.9505 | 0.0033 |
| 750 | 75 | 0.9520 | 0.0022 |
| 800 | 80 | 0.9531 | 0.0015 |

In addition to Table 1, FIG. 8 provides a graphical representation of the inverse proportion of the reflective and transmissive nature of the thin semi-reflective layer 143 based upon the thickness of the gold. Reflective and transmissive values used in the graph illustrated in FIG. 8 are absolute values.

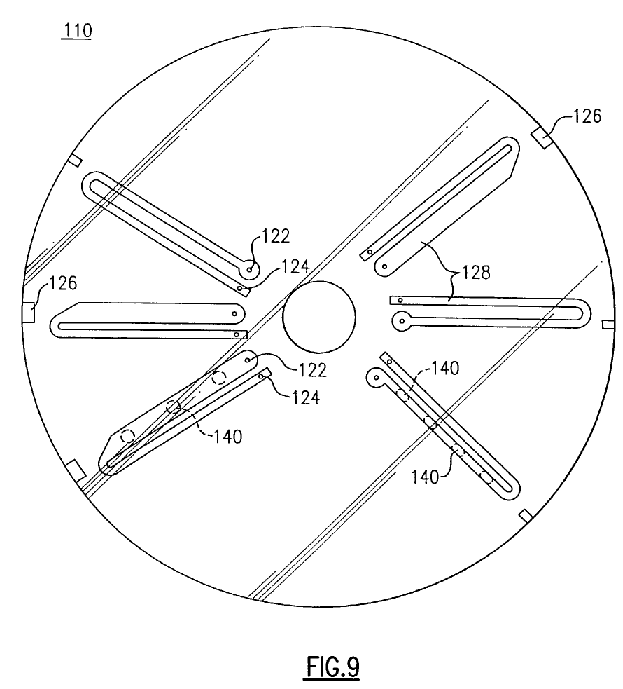

FIG. 9 is a top plan view of the transmissive type optical bio-disc 110 illustrated in FIGS. 6 and 7 with the transparent cap portion 116 revealing the fluidic channels, the trigger markings 126, and the target zones 140 as situated within the disc.

FIG. 10 is an enlarged perspective view of the optical bio-disc 110 according to the transmissive disc embodiment of the present invention. The disc 110 is illustrated with a portion of the various layers thereof cut away to illustrate a partial sectional view of each principal layer, substrate, coating, or membrane. FIG. 10 illustrates a transmissive disc format with the clear cap portion 116, the thin semi-reflective layer 143 on the substrate 120, and trigger markings 126. Trigger markings 126 include opaque material placed on the top portion of the cap. Alternatively the trigger marking 126 may be formed by clear, non-reflective windows etched on the thin reflective layer 143 of the disc, or any mark that absorbs or does not reflect the signal coming from the trigger detector 160 in FIG. 17.

FIG. 10 also shows the target zones 140 formed by marking the designated area in the indicated shape or alternatively in any desired shape. Markings to indicate target zone 140 may be made on the thin semi-reflective layer 143 on the substrate 120 or on the bottom portion of the substrate 120 (under the disc). Alternatively, the target zones 140 may be formed by a masking technique that includes masking the entire thin semi-reflective layer 143 except the target zones 140. In this embodiment, target zones 140 may be created by silk screening ink onto the thin semi-reflective layer 143. An active layer 144 may be applied over the thin semi-reflective layer 143. In the preferred embodiment, the active layer 144 is a 40 to 200 μm thick layer of 2% polystyrene. Alternatively, polycarbonate, gold, activated glass, modified glass, or modified polystyrene, for example, polystyrene-co-maleic anhydride, may be used. The active layer 144 may also be preferably formed through derivatization of the reflective layer 142 with self assembling monolayers such as, for example, dative binding of functionally active mercapto compounds on gold and binding of functionalized silicone compounds on aluminum. In addition hydrogels can be used. As illustrated in this embodiment, the plastic adhesive member 118 is applied over the active layer 144. If the active layer 144 is not present, the adhesive member 118 is directly applied over the semi-reflective metal layer 143. The exposed section of the plastic adhesive member 118 illustrates the cut out or stamped U-shaped form that creates the fluidic circuits 128. The final principal structural layer in this transmissive embodiment of the present bio-disc 110 is the clear, non-reflective cap portion 116 that includes inlet ports 122 and vent ports 124.

Optical Bio-Discs: Peripheral-Circumferential Reservoir Embodiment

FIG. 11 is an exploded perspective view of the principal structural elements of yet another embodiment of the optical bio-disc 110 of the present invention. This embodiment is generally referred to herein as a “reservoir disc”. This embodiment may be implemented in either the reflective or transmissive formats discussed above. In the alternative, the optical bio-disc according to the invention may be implemented as a hybrid disc that has both transmissive and reflective formats and further any desired combination of fluidic channels and circumferential reservoirs.

The principal structural elements of this reservoir embodiment similarly include a cap portion 116, an adhesive member or channel layer 118, and a substrate 120. The cap portion 116 includes one or more inlet ports 122 and one or more vent ports 124. The cap portion 116 is preferably formed from polycarbonate and may be either left clear or coated with a reflective surface 146 when implemented in the reflective format as in FIG. 5. In the preferred embodiment reflective reservoir disc, trigger markings 126 are included on the surface of the reflective layer 142. Trigger markings 126 may include a clear window in all three layers of the bio-disc, an opaque area, or a reflective or semi-reflective area encoded with information that sends data to a processor 166, as shown in FIG. 17, that in turn interacts with the operative functions of the interrogation or incident beam 152 in FIG. 17. According to one aspect of the present invention, trigger markings 126 are as wide as the respective fluidic circuits 128.

The second element shown in FIG. 11 is the adhesive member or channel layer 118 having fluidic circuits or straight channels 128 formed therein. According to one embodiment of the present invention, these fluidic circuits 128 are directed along the radii of the disc as illustrated. The fluidic circuits 128 are formed by stamping or cutting the membrane to remove the plastic film and form the shapes as indicated.

The third element illustrated in FIG. 11 is the substrate 120. The substrate 120 is preferably made of polycarbonate and has either the reflective metal layer 142 or the thin semi-reflective metal layer 143 deposited on the top thereof depending on whether the reflective or transmissive format is desired. As indicated above, layers 142 or 143 may be formed from a metal such as aluminum, gold, silver, nickel, and reflective metal alloys. The substrate 120 is provided with a reservoir 129 along the outer edge that is preferably implemented as the peripheral-circumferential reservoir 129 as illustrated.

FIGS. 12A, 12B, and 12C are different embodiments of substrate 120 including a variety of different implementations of the reservoir aspect of the present invention. More specifically, FIG. 12A shows the substrate 120 including two concentric reservoirs separated by raised portions or land segments 135. As illustrated, this embodiment includes an inner reservoir 131 and an outer reservoir 133. These raised portions or land segments 135 are acute in shape as shown and are arranged to form openings or pass-through ports 137 at preferably regular intervals to thereby place the inner reservoir 131 and an outer reservoir 133 in fluid communication with each other.

With reference now to FIG. 12B, there is shown another embodiment of substrate 120 including segmented or divided circumferential reservoirs 139. Each of these independent arc shaped reservoirs 139 are fluidly isolated or separated from one another by elevated portions of the substrate 120 as shown. FIG. 12B shows 4 independent arc shaped reservoirs 139 for illustrative purposes. As one skilled in the art will appreciate, however, any desired number reservoirs and configurations may be implemented.

Referring next to FIG. 12C, there is shown a modified embodiment of substrate 120 of FIG. 12A. In this embodiment, substrate 120 has one or more mixing wells 141. The mixing wells 141 may be circular or radially directed as illustrated.

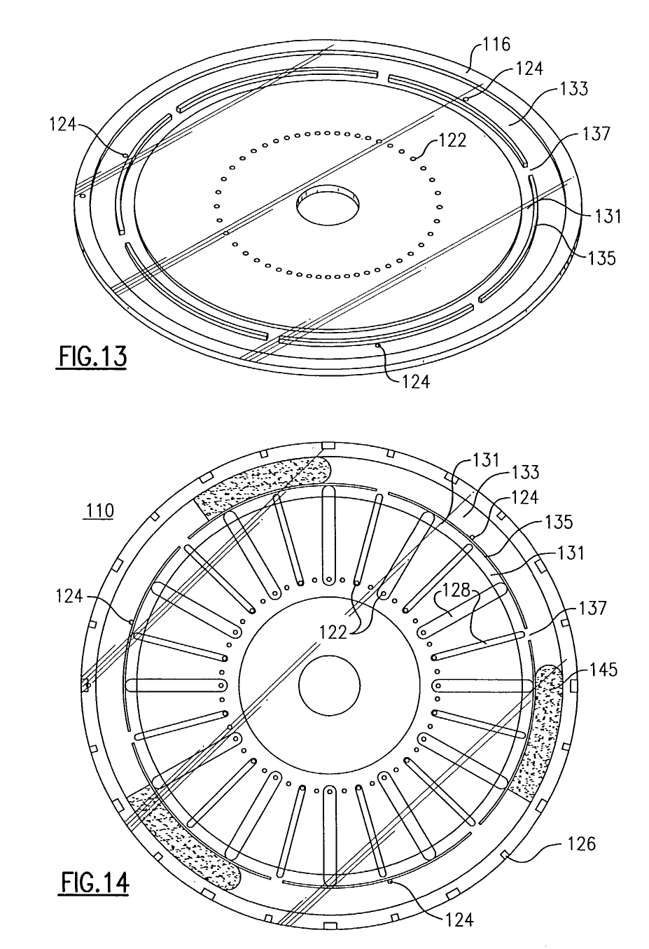

FIG. 13 illustrates an alternate embodiment of cap portion 116. In this embodiment, the reservoir system illustrated in FIG. 12A is formed in the cap 116 as illustrated rather than in the substrate 120. As would be readily apparent to one of skill in the art given the present disclosure, the reservoir systems illustrated in FIGS. 12B and 12C could similarly be formed in the cap 116.

FIG. 14 is a top plan view of a reservoir disc embodiment of the optical bio-disc 110 including the peripheral reservoir system shown in FIGS. 11A and 12 as implemented in the transmissive format. As illustrated, the three principal structural elements are assembled wherein the cap portion 116 is the top layer, adhesive portion 118 is the middle layer, and substrate 120 is the bottom layer. According to one or more modified embodiments of the disc assembly shown in FIG. 14, the reservoir system may be of the type shown in any one of FIGS. 12A, 12B, and 12C as formed in either the cap 116 or substrate 120.

As shown generally in FIGS. 14, 15, and 16, the fluidic channel 128 is placed in fluid communication with the reservoir 129 or 131. In this manner, fluid deposited in the inlet port 122 is directed through the channel 128 and then into the reservoir 129 or 131 during processing of the assay in the disc drive. In the embodiment shown in FIG. 14, waste fluid is further directed to the outer reservoir 133 by way of pass through ports 137 and then optionally into absorber pads 145. Absorber pads 145 may be optionally filled with drying agents or desiccants to keep all reagents deposited in the optical bio-disc 110 free of moisture to preserve functional activity of the reagents and increase the shelf life of the bio-disc 110.

In accordance with a more particular embodiment of the present invention, the reservoir may include one or more absorber pads 145 as illustrated in FIG. 14. The absorber pads may be preferably formed form a material such as cellulose glass fiber, or any other type of suitable absorbing material. The pads 145 are preferably evenly distributed around the reservoir to thereby promote and maintain balance of the disc while in use during rotation in the drive

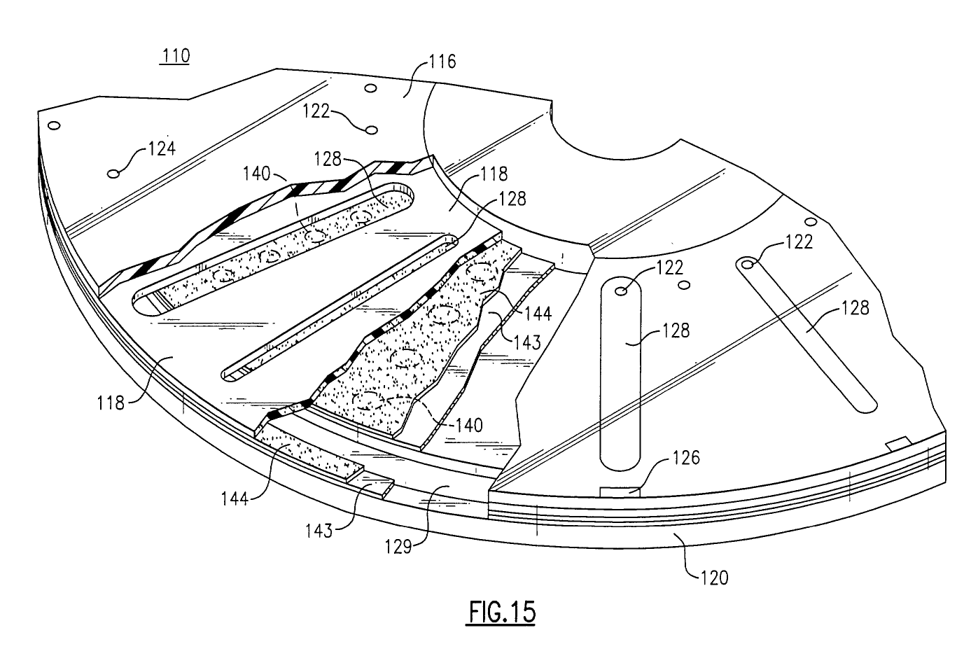

Moving on now specifically to FIG. 15, there is presented an enlarged perspective view of the optical bio-disc 110 according to the reservoir disc embodiment of the present invention. The disc 110 is illustrated with a portion of the various layers thereof cut away to illustrate a partial sectional view of each principal layer, substrate, coating, or membrane. FIG. 15 illustrates a reservoir disc in the transmissive format with the clear cap portion 116, the thin semi-reflective layer 143 on the substrate 120, and trigger markings 126. Trigger markings 126 include opaque material placed on the top portion of the cap. Alternatively the trigger marking 126 may be formed by clear, non-reflective windows etched on the thin reflective layer 143 of the disc, or any mark that absorbs or does not reflect the signal coming from the trigger detector 160 in FIG. 17.

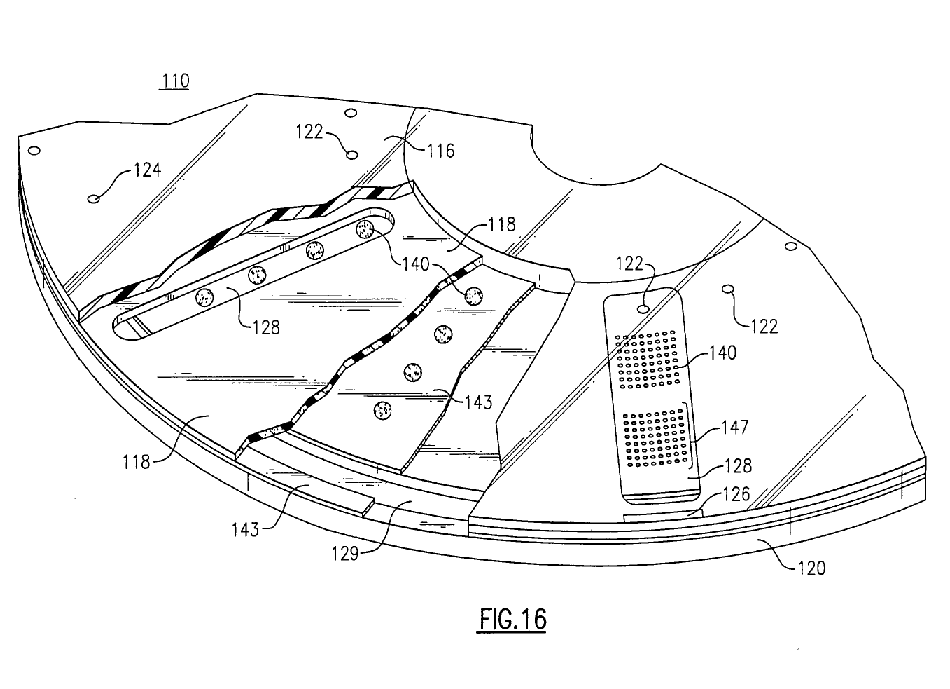

FIG. 15 also shows an active layer 144 that may be applied over the thin semi-reflective layer 143. In the preferred embodiment, the active layer 144 is a 40 to 200 μm thick layer of 2% polystyrene. Alternatively, polycarbonate, gold, activated glass, modified glass, or modified polystyrene, for example, polystyrene-co-maleic anhydride, may be used. The active layer 144 may also be preferably formed through derivatization of the reflective layer 142 with self assembling monolayers such as, for example, dative binding of functionally active mercapto compounds on gold and binding of functionalized silicone compounds on aluminum. In addition hydrogels can also be used. As illustrated in this embodiment, the plastic adhesive member 118 is applied over the active layer 144. If the active layer 144 is not present, the adhesive member 118 is directly applied over the semi-reflective metal layer 143 as shown in FIG. 16 which is discussed in further detail below. The exposed section of the plastic adhesive member 118 illustrates the cut out or stamped straight shaped form that creates the fluidic circuits 128. The exposed section of the substrate 120 illustrates the peripheral circumferential reservoir 129. The final principal structural layer in this embodiment of the present bio-disc 110 is the clear, non-reflective cap portion 116 that includes inlet ports 122 and vent ports 124. As would be readily apparent to one of skill in the art given the present disclosure, the various embodiments of the substrate 120, illustrated in FIGS. 12A, 12B, and 12C could be used as the substrate of the disc illustrated in FIG. 15.

FIG. 16 is a view similar to FIG. 15 showing an alternate embodiment of the transmissive reservoir disc using discrete capture zones 140 rather than an active layer 144. The discrete capture zones 140 may be positioned at any pre-determined locations on the metal layer 143 and distributed in the fluidic circuit 128 as illustrated. FIG. 16 further shows, a wide-format straight channel 128 having several discrete capture zones 140 arranged in a micro-array format 147. According to an embodiment of the present invention, the fluidic circuit 128 of FIG. 16 is wide enough to accommodate multiple sets of micro arrays 147 from a minimum size of 2×2 capture zones to in excess of 1,000×1,000 capture zones. As would also be readily apparent to one of skill in the art given the present disclosure, the various embodiments of the substrate 120, illustrated in FIGS. 12A, 12B, and 12C could also be used as the substrate of the disc illustrated in FIG. 16.

Controlling Drive Functions

The optical disc system portion (10 of FIG. 2) of the present invention is an intricate system that must operate with precision to correctly analyze the aforementioned optical bio-disc embodiments or equivalent embodiments. In order for the optical disc system to correctly operate it must: (1) accurately focus on the operational plane of the optical disc assembly; (2) accurately follow the spiral disc track or utilize some form of uniform radial movement across the disc surface; (3) recover enough information to facilitate a form of speed control (CAV, CLV, or VBR); (4) maintain the proper power control by logical information gathered from the disc or by signal levels detected from the operational plane of the disc; and (5) respond to logic information that is used to control the position of the objective assembly, speed of rotation, or focusing position of the laser responsible for providing operational requirements.

An optical disc drive controller assembly performs three principal operational requirements by utilizing electrical and logical servos. An optical disc drive controller assembly thus controls: (1) the focusing servo circuitry, (2) the tracking servo circuitry, and (3) the information processing circuitry. In the case of a CD recordable system, a fourth requirement is necessary to provide power control. In these systems, the optical disc drive controller assembly also provides an electrical signal to the laser power control circuitry (“Signal Monitor”).

Optical Bio-Drive Components

FIG. 17 is a representation in perspective and block diagram illustrating the inner component of optical disc drive 10. Shown in the figure are optical components 148, a light source 150 that produces the incident or interrogation beam 152, a return beam 154, and a transmitted beam 156. In the case of the reflective bio-disc illustrated in FIG. 5, the return beam 154 is reflected from the reflective surface 146 of the cap portion 116 of the optical bio-disc 110. In this reflective embodiment of the present optical bio-disc 110, the return beam 154 is detected and analyzed for the presence of signal agents by a bottom detector (e.g. quad detector) 157. In the transmissive bio-disc format, on the other hand, the transmitted beam 156 is detected, by top detectors 158, and is also analyzed for the presence of signal agents. In the transmissive embodiment, photo detectors may be used as top detectors 158. In one embodiment top detectors 158 is a multi-element detector or a split detector. A more detailed description of how the detection process is conducted with different disc embodiments is given in next section titled “Detectors and Optical Bio-Disc Types.”

FIG. 17 also shows a hardware trigger mechanism that includes the trigger markings 126 on the disc and a trigger detector 160. The hardware triggering mechanism is used in reflective bio-discs, transmissive bio-discs, peripheral-circumferential reservoir bio-discs and any other equivalent embodiments. The triggering mechanism allows the processor 166 to collect data only when the interrogation beam 152 is on a respective target zone 140. Furthermore, in the transmissive bio-disc system, a software trigger may also be used. The software trigger uses the bottom detector to signal the processor 166 to collect data as soon as the interrogation beam 152 hits the edge of a respective target zone 140. FIG. 17 also illustrates a drive motor 162 and a controller 164 for controlling the rotation of the optical bio-disc 110. FIG. 17 further shows the processor 166 and analyzer 168 implemented in the alternative for processing the return beam 154 and transmitted beam 156 associated with the transmissive optical bio-disc.

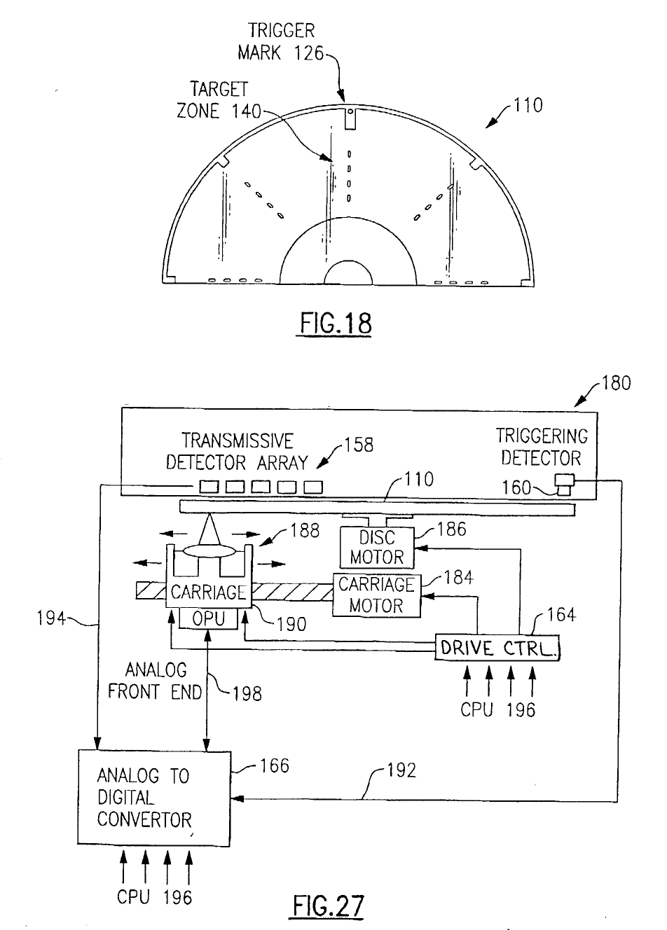

As shown in FIG. 17, triggering mechanism is needed to control the start and end of analysis. FIG. 18 shows a plan view of disc 110 with target zones 140 and trigger marks 126. Hardware trigger mark 126 is preferably disposed at an outer periphery of the disc, and preferably is in a radial line with target zones 140. Capture trigger card 170 (in FIG. 17) provides a signal indicating when trigger mark 126 has reached a predetermined position with respect to an investigational feature of interest. This signal is processed through into processor 166 to synchronize processing that takes place in processor 166 with the location of trigger mark 126. For example, trigger mark 126 is placed just prior to a sector in bio-disc 110 containing investigational structures.

Trigger mark 126 is used as follows. When processor 166 detects trigger mark 126, processor 166 waits a short predetermined delay (td), and then begins processing the signal detected from either quad detector 157 or top detectors 158 as data indicative of the presence of an investigational feature.

Detectors and Optical Bio-Disc Types

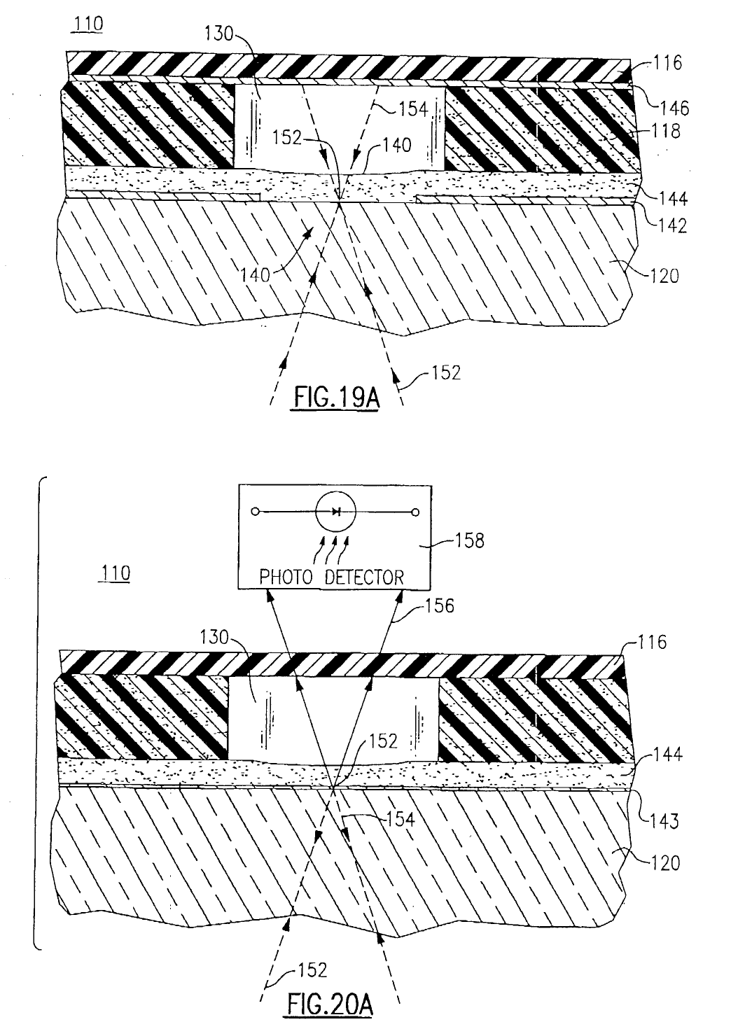

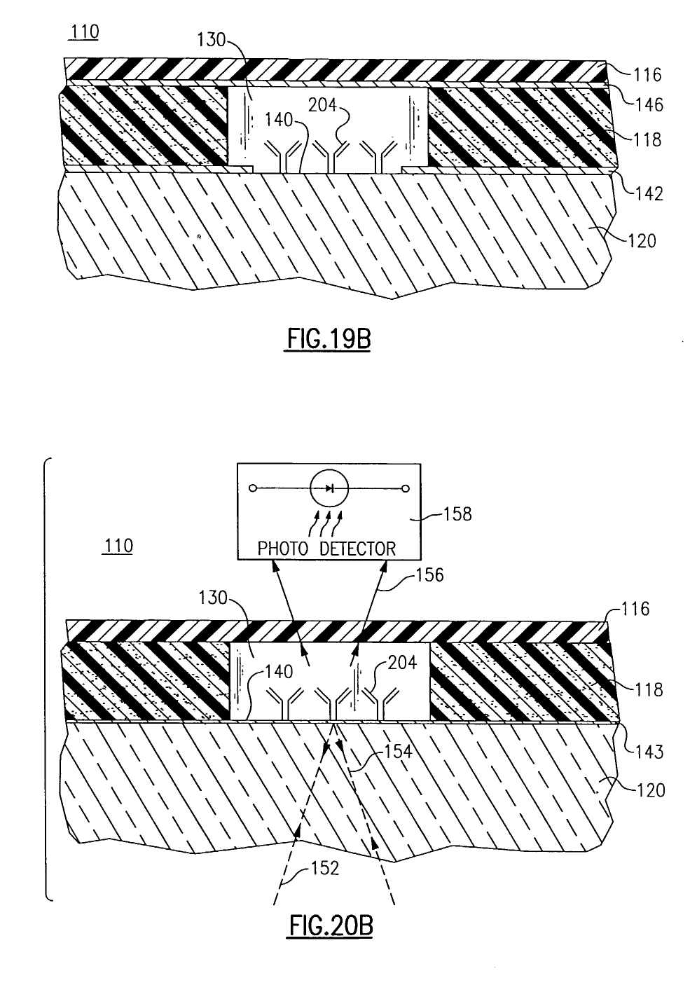

FIG. 19A to FIG. 24 aim to provide a more detailed illustration of the optical paths in various detector and bio-disc embodiments.

FIG. 19A is a partial cross sectional view of the reflective disc embodiment of the optical bio-disc 110 according to the present invention. FIG. 19A illustrates the substrate 120 and the reflective layer 142. As indicated above, the reflective layer 142 may be made from a material such as aluminum, gold or other suitable reflective material. In this embodiment, the top surface of the substrate 120 is smooth. FIG. 19A also shows the active layer 144 applied over the reflective layer 142. As shown in FIG. 19A, the target zone 140 is formed by removing an area or portion of the reflective layer 142 at a desired location or, alternatively, by masking the desired area prior to applying the reflective layer 142. As further illustrated in FIG. 19A, the plastic adhesive member 118 is applied over the active layer 144. FIG. 19A also shows the cap portion 116 and the reflective surface 146 associated therewith. Thus when the cap portion 116 is applied to the plastic adhesive member 118 including the desired cutout shapes, flow channel 130 is thereby formed. As indicated by the arrowheads shown in FIG. 19A, the path of the incident beam 152 is initially directed toward the substrate 120 from below the disc 110. The incident beam then focuses at a point proximate the reflective layer 142. Since this focusing takes place in the target zone 140 where a portion of the reflective layer 142 is absent, the incident continues along a path through the active layer 144 and into the flow channel 130. The incident beam 152 then continues upwardly traversing through the flow channel to eventually fall incident onto the reflective surface 146. At this point, the incident beam 152 is returned or reflected back along the incident path and thereby forms the return beam 154.

FIG. 19B is a view similar to FIG. 19A showing all the components of the reflective optical bio-disc described in FIG. 19A. FIG. 19B further shows capture antibodies 204 attached to the substrate 120 within the capture zone 140.

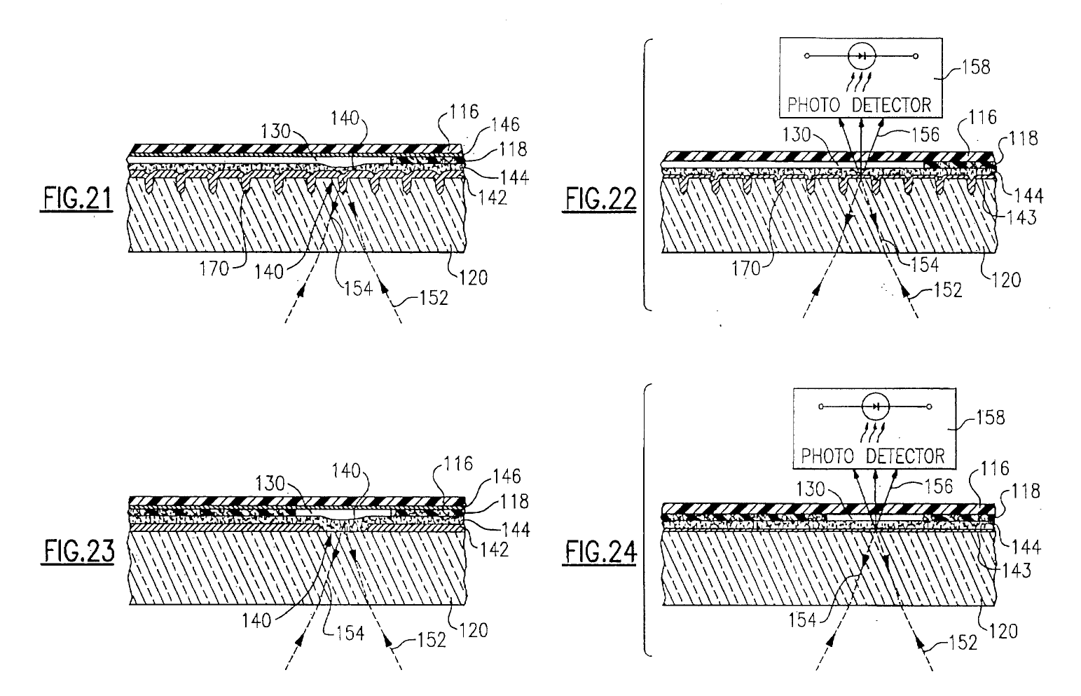

FIG. 20A is a partial cross sectional view of the transmissive embodiment of the bio-disc 110 according to the present invention. FIG. 20A illustrates a transmissive disc format with the clear cap portion 116 and the thin semi-reflective layer 143 on the substrate 120. FIG. 20A also shows the active layer 144 applied over the thin semi-reflective layer 143. In the preferred embodiment, the transmissive disc has the thin semi-reflective layer 143 made from a metal such as aluminum or gold approximately 100-300 Angstroms thick and does not exceed 400 Angstroms. This thin semi-reflective layer 143 allows a portion of the incident or interrogation beam 152, from the light source 150 in FIG. 17, to penetrate and pass upwardly through the disc to be detected by top detectors 158, while some of the light is reflected back along the same path as the incident beam but in the opposite direction. In this arrangement, the return or reflected beam 154 is reflected from the semi-reflective layer 143. Thus in this manner, the return beam 154 does not enter into the flow channel 130. The reflected light or return beam 154 may be used for tracking the incident beam 152 on pre-recorded information tracks formed in or on the semi-reflective layer 143 as described in more detail in conjunction with FIGS. 21 and 22.

In the disc embodiment illustrated in FIG. 20A, a defined target zone 140 may or may not be present. Target zone 140 may be created by direct markings made on the thin semi-reflective layer 143 on the substrate 120. These marking may be done using silk screening or any equivalent method. In the alternative embodiment where no physical indicia are employed to define a target zone, the flow channel 130 in effect is utilized as a confined target area in which inspection of an investigational feature is conducted.

FIG. 20B is a view similar to FIG. 20A showing all the components of the reflective optical bio-disc described in FIG. 20A. FIG. 20B further shows capture antibodies 204 attached to the substrate 120 within the capture zone 140.

FIG. 21 is a cross sectional view taken across the tracks of the reflective disc embodiment of the bio-disc 110 according to the present invention. This view is taken longitudinally along a radius and flow channel of the disc. FIG. 21 includes the substrate 120 and the reflective layer 142. In this embodiment, the substrate 120 includes a series of grooves 170. The grooves 170 are in the form of a spiral extending from near the center of the disc toward the outer edge. The grooves 170 are implemented so that the interrogation beam 152 may track along the spiral grooves 170 on the disc. This type of groove 170 is known as a “wobble groove”. A bottom portion having undulating or wavy sidewalls forms the groove 170, while a raised or elevated portion separates adjacent grooves 170 in the spiral. The reflective layer 142 applied over the grooves 170 in this embodiment is, as illustrated, conformal in nature. FIG. 21 also shows the active layer 144 applied over the reflective layer 142. As shown in FIG. 21, the target zone 140 is formed by removing an area or portion of the reflective layer 142 at a desired location or, alternatively, by masking the desired area prior to applying the reflective layer 142. As further illustrated in FIG. 21, the plastic adhesive member 118 is applied over the active layer 144. FIG. 21 also shows the cap portion 116 and the reflective surface 146 associated therewith. Thus, when the cap portion 116 is applied to the plastic adhesive member 118 including the desired cutout shapes, the flow channel 130 is thereby formed.

FIG. 22 is a cross sectional view taken across the tracks of the transmissive disc embodiment of the bio-disc 110 according to the present invention, as described in FIG. 20A. This view is taken longitudinally along a radius and flow channel of the disc. FIG. 22 illustrates the substrate 120 and the thin semi-reflective layer 143. This thin semi-reflective layer 143 allows the incident or interrogation beam 152, from the light source 150, to penetrate and pass through the disc to be detected by the top detectors 158, while some of the light is reflected back in the form of the return beam 154. The thickness of the thin semi-reflective layer 143 is determined by the minimum amount of reflected light required by the disc reader to maintain its tracking ability. The substrate 120 in this embodiment, like that discussed in FIG. 23, includes the series of grooves 170. The grooves 170 in this embodiment are also preferably in the form of a spiral extending from near the center of the disc toward the outer edge. The grooves 170 are implemented so that the interrogation beam 152 may track along the spiral. FIG. 22 also shows the active layer 144 applied over the thin semi-reflective layer 143. As further illustrated in FIG. 22, the plastic adhesive member 118 is applied over the active layer 144. FIG. 22 also shows the cap portion 116 without a reflective surface 146. Thus, when the cap is applied to the plastic adhesive member 118 including the desired cutout shapes, the flow channel 130 is thereby formed and a part of the incident beam 152 is allowed to pass there through substantially unreflected.

FIG. 23 is a view similar to FIG. 19A showing the entire thickness of the reflective disc and the initial refractive property thereof. FIG. 24 is a view similar to FIG. 20A showing the entire thickness of the transmissive disc and the initial refractive property thereof. Grooves 170 are not seen in FIGS. 23 and 24 since the sections are cut along the grooves 170. FIGS. 23 and 24 show the presence of the narrow flow channel 130 that are situated perpendicular to the grooves 170 in these embodiments.

FIGS. 21, 22, 23, and 24 show the entire thickness of the respective reflective and transmissive discs. In these figures, the incident beam 152 is illustrated initially interacting with the substrate 120 which has refractive properties that change the path of the incident beam as illustrated to provide focusing of the beam 152 on the reflective layer 142 or the thin semi-reflective layer 143.

Top Detector

Testing has shown that top detector can deliver improved signal-to-noise ratio in optical bio-drives. Thus, as shown in FIG. 17, embodiments of optical bio-drive may be comprised of a top detector and its related detection circuitry. Since the top detector is not a common component found in conventional optical drives (e.g. CD-R, DVD) available in the market today, it is advantageous to implement the top detector in a way that provides the least amount of disruption to conventional drives. For this reason, it is desirable to use a transmissive bio-disc embodiment. In the transmissive case, the bio-disc is reflective enough for the operational data to be seen by the active electronics and normal drive functioning to occur. Yet, still partially transmissive to allow some of the incident light to pass through the disc to a top detector. In this manner, the investigational features can be detected by adding a top detector to conventional drives. An investigational feature can be a cell, a bead or any other biological material of interest in an assy. No modification in the detection circuitry for reflected light (quad detector) is needed. The reflected light can still be used to read encoded data as well as provide operational functions such as tracking and focusing as before.

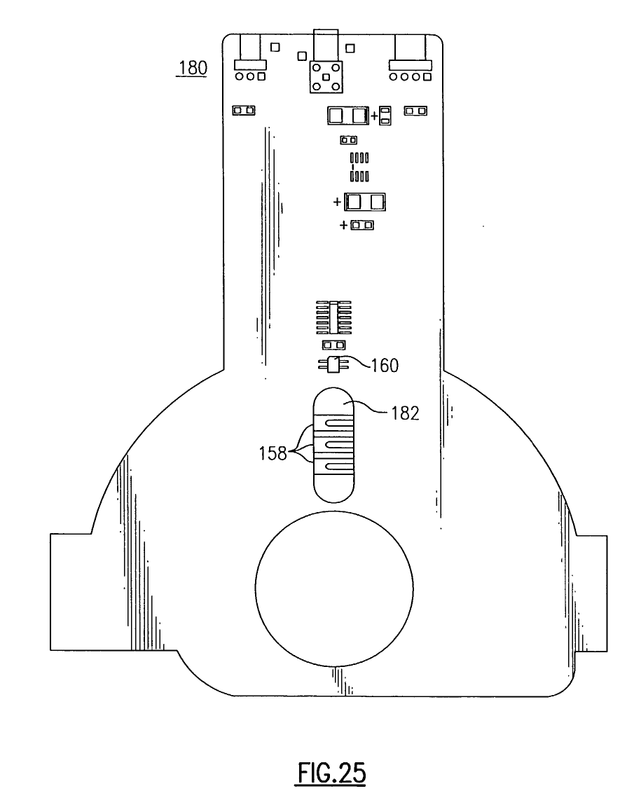

In one embodiment, the modification of conventional drives is accomplished by adding a trigger, amplifier, detector (TAD) card 180 (FIG. 25). The trigger, amplifier, detector (TAD) card 180 is preferably constructed in such a manner that it can be mounted within a conventional optical disc drive. One suitable drive used particularly for development purposes is the Plextor model 8220 CD-R drive. While a CD or DVD can be used, a CD-R drive has several useful aspects. Because the CD-R drive allows reading and writing functions, the laser can operate over a higher range of power levels. This functionality of using higher power can be useful for certain types of investigational features. Another useful aspect of a CD-R is that it has the ability to write onto a disc and therefore can be used to write results back onto a disc. This allows results to be saved back onto the disc for later use and to remain with the disc.

FIG. 25 is a top view of TAD 180 including a triggering detection assembly according to another aspect of the present invention. The circuit board includes an opening or pass-through port 182 which is needed when implemented in a top detector drive arrangement utilizing a transmissive disc such as those disclosed in commonly assigned U.S. Pat. No. 5,892,577 entitled “Apparatus and Method for Carrying Out Analysis of Samples,” incorporated herein by reference, and U.S. Provisional Application No. 60/247,465 entitled “Disc Drive for Optical Bio-Disc,” also incorporated herein by reference. When employed with conventional drives using reflective bio-discs and a typically positioned proximal or bottom detector, the pass-through port 182 is not required. As discussed in conjunction with FIG. 17, the TAD 180 includes trigger sensor 160 and the detectors 158.

FIG. 26 is an electrical schematic of the triggering circuit shown in FIG. 25. To acquire information concerning the investigational features, the optical bio-drive according to the present embodiment is provided with suitable triggering circuitry implemented to trigger when the assay area of interest is in the incident laser beam.

FIG. 27 is a block diagram that illustrates in more detail the inter-relationship between TAD 180 and the disc drive mechanisms. As it is shown here, optical components 188 are mounted on a carriage assembly 190 that is driven by a carriage motor 184, and the disc is driven by the disc motor 186. The carriage assembly 190 includes an optical pick-up unit (OPU). Controller 164, which receives signals from CPU 196, drives the two motors. Signal data 198 from the optical components 188, triggering detector signal 192, and signals 194 from top detector (or detector array) 158 are all provided to ADC (Analog to Digital Converter) 150 or S-curve recognition circuitry as described later. FIG. 27 shows again that TAD 180 comprises top detector (or detector array) 158 and triggering detector 160. TAD is mounted on top of the optical drive objective assembly.

Those skilled in the art can appreciate that the configuration shown in FIG. 27 is just an example configuration only. Comparable configurations may have different detector locations. The detector for processing the signal from the transmitted or reflected beam of light may be a single detector element or an array of multiple elements arranged radially or circumferentially, and may be placed on the opposite side of the disc from the laser, and may be mounted directly on the TAD or separately. ADC 150 may optionally be located on a sampling card that allows for very high-speed conversion. One usable card is the Ultrad AD 1280 DX, which has two 12-bit A/D converters sampling up to forty million samples per second. ADC 150 is controlled by CPU 196.

Rationale for Segmented Detector

An embodiment of the present invention is a segmented detector that takes advantage of some important optical properties to improve imaging of cells and other investigational features. Applicants of the present invention observed that a spherical object is not imaged primarily by the variations in reflection level it causes, but through refracting the laser beam away from its normal line of travel. There are two principle mechanisms at work:

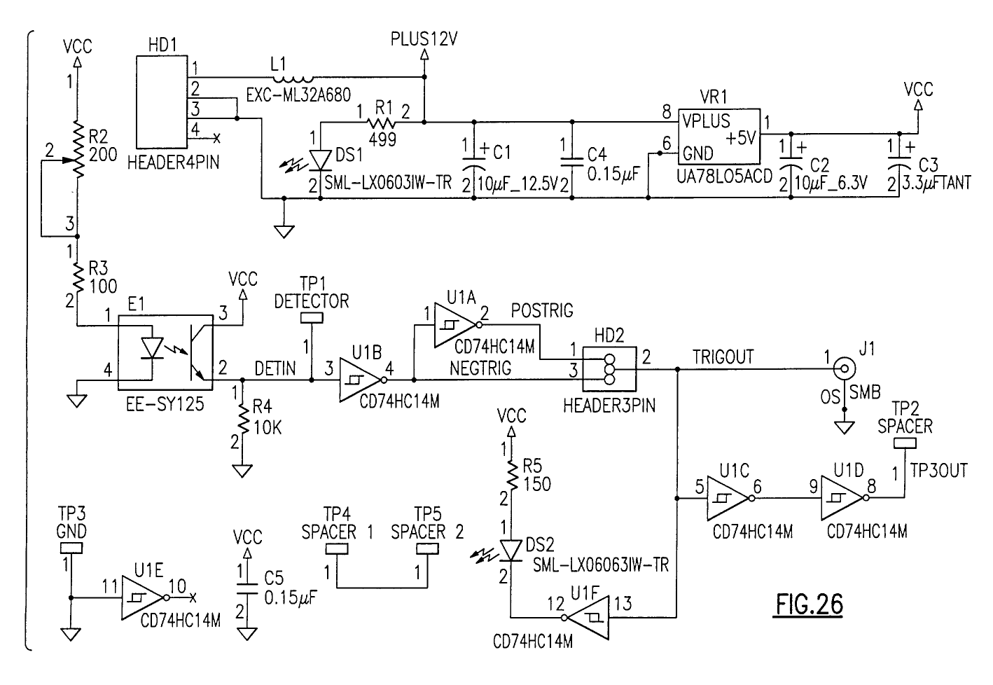

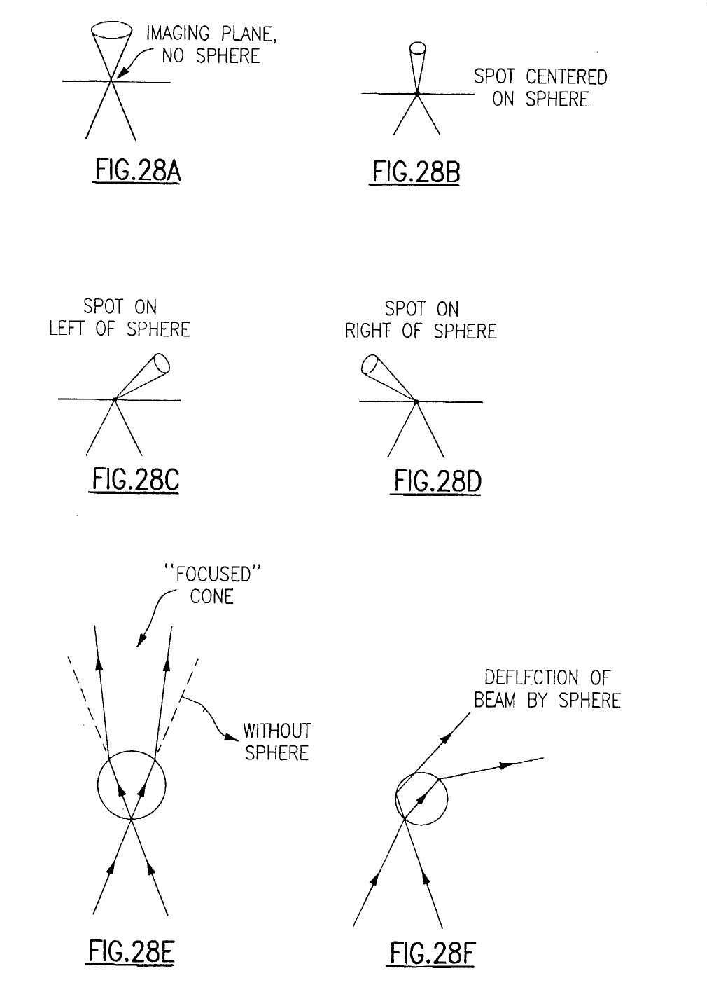

(1) The spherical object acts as a microlens, focusing the light that was incident upon it in a cone into a narrower cone. For spheres or cells in the few micron size range, this focusing can reduce the cone angle by a factor of three or so. Hence light incident with a numerical aperture of 0.45 will exit with most of the light within a numerical aperture of 0.2 or so. The comparison is shown in FIG. 28A and 28B. The up close illustration of the optical paths is given in FIG. 28E.

(2) When light is not centered on the sphere but is focused off to one side, the sphere deflects light sideways (FIG. 28C and FIG. 28D). This angular deviation can be over 30 degrees. An up close illustration of the optical paths is given in FIG. 28F. If the detection system is, as normal, centered on the imaging spot, the light will miss the detector and the sides of the sphere will appear dark in the image.

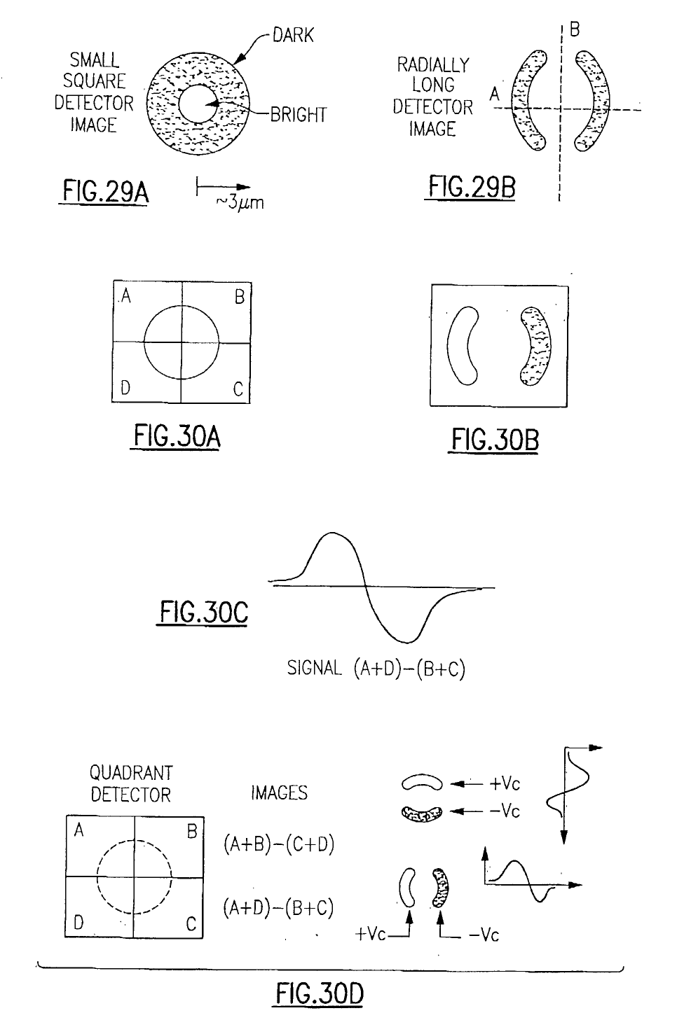

If a detector is placed behind the disc (e.g. a top detector that detects transmitted light), then its size and shape significantly affects the signals. For a detector that is long in the radial direction of the disc (from center to the edge), the images lose their spherical symmetry and take the form of two ‘banana’ shaped dark patches, as shown in FIG. 29B (also see Appendix A—‘Imaging of a Bio-Compact Disc, pt I’, section 6.2). The reason for this is that any light deflected radially still falls on the detector, and therefore gives no contrast, whilst light deflected tangentially results in a lower signal since it misses the detector. Compare the shapes of the detected images of FIG. 29B to that of FIG. 29A. FIG. 29A is the detected image from a square detector smaller than the normal laser beam diameter in the absence of a cell or spherical object.

Likewise, if a radially-long detector is offset tangentially by an amount greater than the width of the transmitted but undeflected cone of light, then one side of the image becomes bright, and the rest dark. This gives a very distinctive signal from a sphere. A detector placed on the other side gives a bright image corresponding to the opposite side of the sphere. Thus for example, incident light entering a right half of a sphere would show up on a detector placed to the left of the sphere.

The same principle applies to detectors in reflection, where there is a mirror behind the cell to redirect transmitted light back towards the objective lens. In this case, except that only light that passes through the objective lens aperture is detected, and detectors that would detect light outside this region never capture light.

Therefore, in order to effectively distinguish spherical objects such as cells from other objects that may be on the optical bio-disc, a detector that is segmented in the tangential direction is needed. When the light is focused and deflected sideways by the sphere, it will fall first on segments to one side, and then on segments to the other side. Taking these segments either separately or in combinations yields signals that are distinctive for spherical objects.

Segmented Detector Implementations

For reflective systems, all light must pass through the aperture of the objective lens on the return path, and therefore detectors cannot detect light deflected by more than the NA of the lens. However, due to the focusing action of the sphere, segments detecting light primarily on the left or right side of the pupil will yield a higher signal on either the left or right pair of segments in a quadrant detector. If they can be accessed independently and appropriately combined, they can be used to generate images showing the cells. In particular, the tangential push-pull signal will give the information in a recognizable form, with a white ‘banana’ next to a dark ‘banana’. FIG. 30A shows the quad detector with four quadrants A, B, C and D detecting a incident beam without sphere. In FIG. 30B, the detector combination (A+D)−(B+C) gives the banana shaped signals generated by light through a sphere. In FIG. 30C, push-pull signal generated by (A+D)−(B+C) is shown. The graph is signal voltage vs. time plot. The unique shape of this curve can be used to recognize cells at the signal level. The shape of this curve is called the S-curve.

If the detector is moved along with the light spot (or optical head), then the use of a quadrant detector, and using the radial and tangential ‘push-pull’ signals as shown in FIG. 30D will give a distinctive pair of signals that can be used for cell/bead identification. This quadrant detector may again be smaller than the light spot for enhanced signal, and optionally surrounded by other detection areas for detection of all undeflected light.

For transmissive systems with top detectors, there is no objective aperture to limit the area over which detector segments can be placed. The use of a detector that is extended in the radial direction has three advantages: (1) it removes sensitivity to the radial position of the readout; (2) it removes effects originating from the grooves on the disc; and (3) it creates distinctive images from spheres that can be easily recognized.

Any segment configuration in transmission that allows a distinction to be made to light deflected to the left and right of the readout spot can be used to distinguish spheres. The present invention includes several particularly useful configurations:

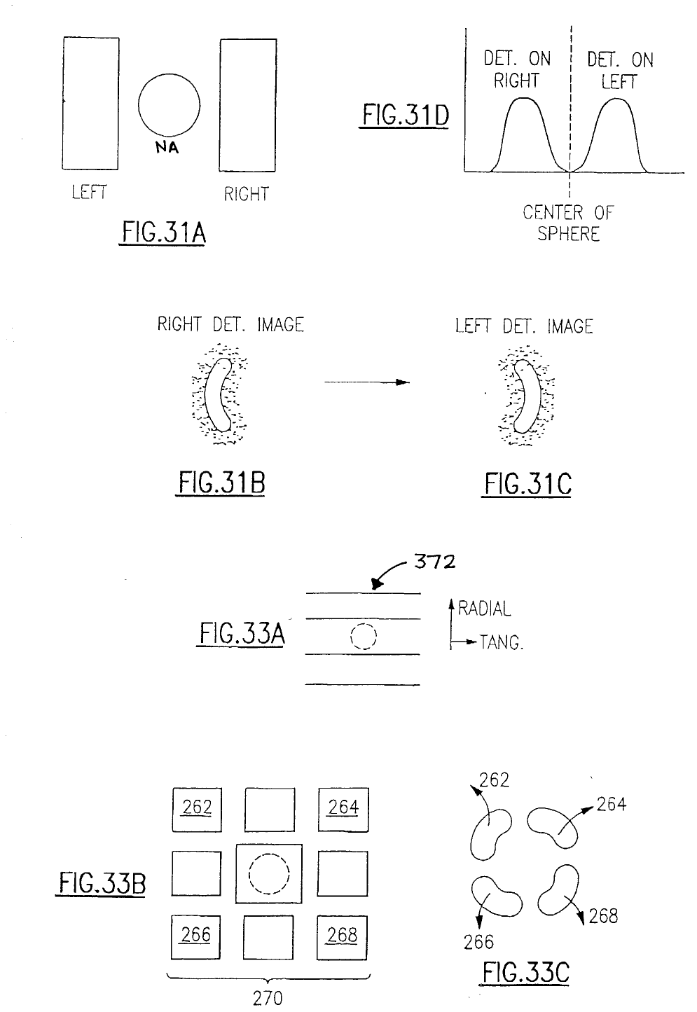

(1) Left and right segments outside the numerical aperture (NA) of the objective lens, such that only light deflected by more than this angle is detected (FIG. 31A). The circle in the middle of FIG. 31A indicates the size of the NA. This gives a large reduction in the background signal arising from unscattered light. Light deflected by spheres is distinguishable from the signal first arising on one detector segment and then the other (FIGS. 31B and 31C). The signal of the detector configuration is shown in FIG. 31D. Various methods are available for detecting this phenomenon, including image recognition of simultaneously acquired images, and real-time electronic strategies such as signal additions after phase delays and digital signal gating methods.

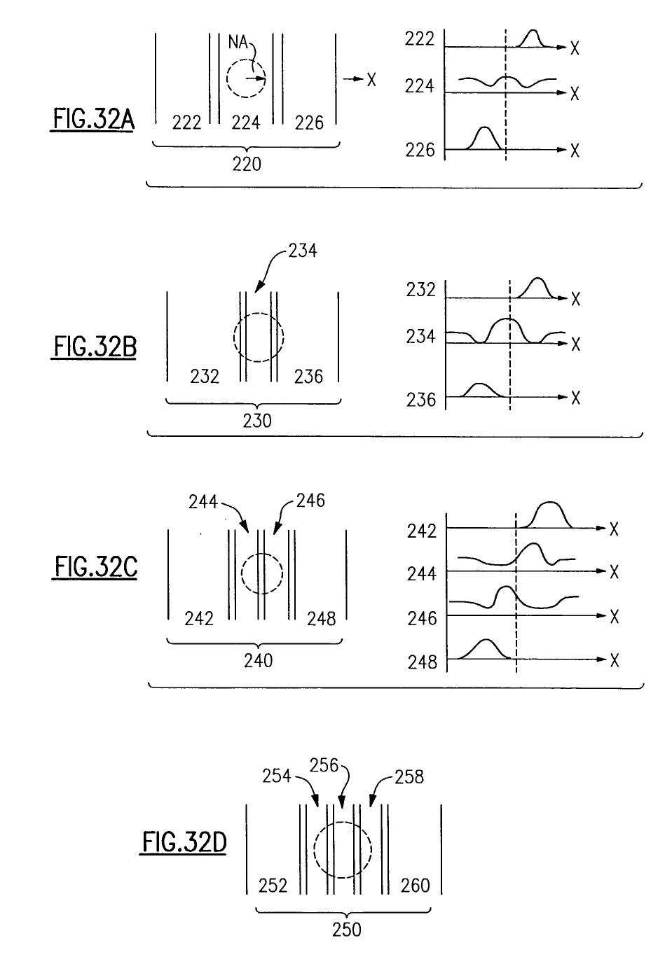

(2) Besides having segments to the left and right, there can be a central detector for normal imaging purposes. If this detector segment is thinner than the tangential numerical aperture of the system, then due to the focusing of the light by the sphere, there is a signal increase when the spot is centered on the sphere. Hence any detector configuration in which a central segment is narrower than the NA of the objective lens can be used for distinguishing cells. FIGS. 32A, 32B, 32C and 32D show various configurations and their respective signals. FIGS. 32A and 32B show two embodiments (220 and 230). Detector 220 comprises a left detector segment (222), a right detector segment (226) and a center detector segment (224). Detector 230 also comprises a left detector segment (232), a right detector segment (236) and a center detector segment (234). The only difference between the two embodiments is the width of the center detector. If the central detector segment is divided into two narrow segments (244 and 246) as in detector 240 of FIG. 32C, they will show high-signal peaks offset from each other, similar to the signal detected in reflective systems. Finally, FIG. 32D shows a 5-segment detector. Detector segments 252 and 260 detect deflected light while segments 254, 256 and 258 detect focusing effect of a sphere. Segments outside the NA of the objective lens may be combined with segmentation within it to further enhance cell recognition.

When the region in which spheres may be located is narrowly confined in a radial direction, then it is not advantageous to have a long detector. Then the segmentation described here in a tangential direction may also be applied in a radial direction, with detector segments on the inner and outer radii. This detector embodiment (272) is shown in FIG. 33A. Moreover, it is then possible to combine these two, and have segments along the diagonals, as shown in detector 270 of FIG. 33B. Detector 270 comprises segments 262, 264, 266 and 268, each located in a corner of the diagonal setup. FIG. 33C gives a pictorial representation of the detected light areas using the detector segments 262, 264, 266 and 268 of the segmented detector 270 of FIG. 33B. The key point is that along any diameter of the detected sphere, light will first be deflected to one side and then to the other, and if detector segments are present to detect this deflected light, the sphere may be identified.

As an addendum to the use of a detector with radial segmentation, if the detector moves in the radial direction with the focused light spot, then the detector does not need to be ‘long’, and any detector segmentation is possible. As a further possibility, a CCD array like those used in digital cameras may be used as detectors, and full image analysis of the scattered light becomes possible. (However, CCD's are relatively slow and expensive.)

It is not necessary that a detector be physically placed in the light collection areas shown in the figures. It is also possible to have other light collection means, such as mirrors or lenses that direct light to detectors that are located elsewhere; it is only necessary that the light traveling through the relevant solid angles be collected and detected.

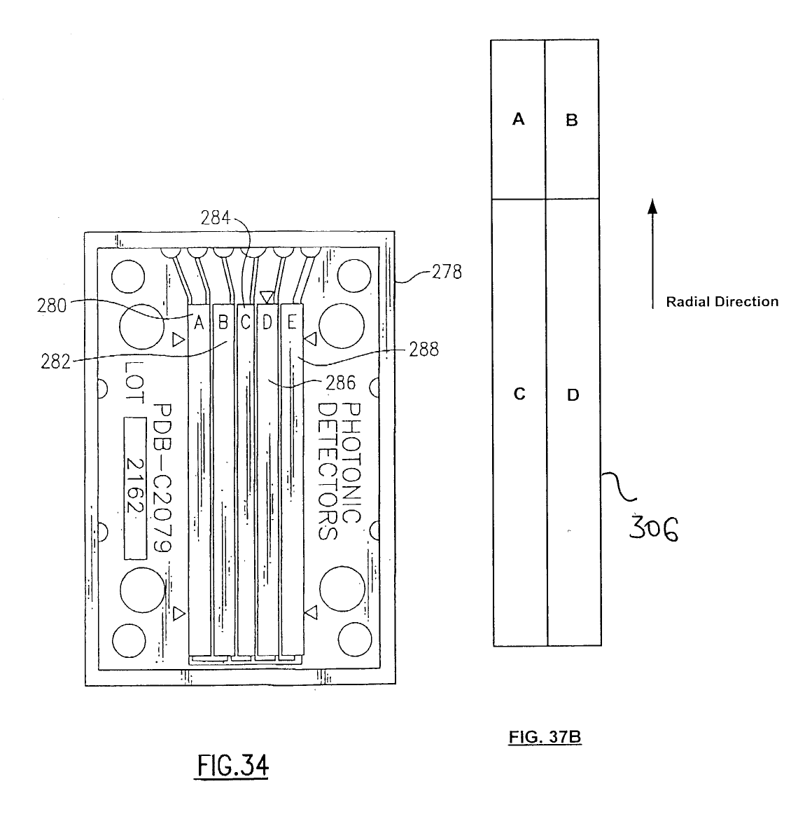

FIG. 34 is an illustration of a multi-element (segmented) detector 278 according to one embodiment of the present invention. It contains 5 separate detector segments marked A (280), B (282), C (284), D (286) and E (288). As discussed above, using such a detector to detect the focused and deflected incident light leads to significant improvement in signal-to-noise ratio. The combining signals from a segmented (multi-element) detector to produce the effect of one large detector also minimizes the disc wobble effect on the signal level—this is especially important to assays that work using the principles of colorimetry. Results from tests performed using the multi-element detector shows a stronger resultant signal from using C−(A+B+D+E). The strong signal minimizes the effect of background noise.

Spilt (Bi-Segmented) Detector

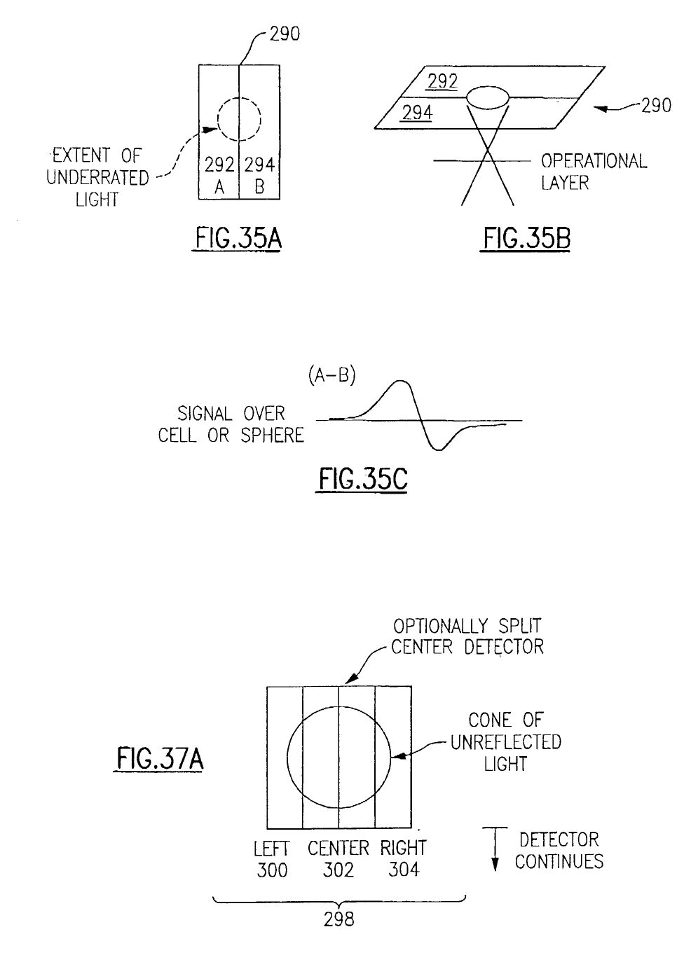

A particular embodiment of the detector described above is the use of a detector that is divided into two along the radial direction. The tangential extent of this detector may be either smaller than or greater than the numerical aperture of the lens, but usually it will be greater than the NA. The dividing line is ideally centered on the transmitted light spot, i.e. the optic axis falls on the dividing line. FIG. 35A offers a top view of this configuration (292) while FIG. 35B offers a 3-D view. There are two segments, segment A 292 and segment B 294.

The advantage of this detector is that it combines simplicity (and therefore low cost) with the ability to provide a differential signal that is clearly distinguishable for cells. The resulting signal plot (voltage vs. time) of (A−B) is shown in FIG. 35C. The differential nature of the signal provided by subtracting one detector output from the other reduces the noise level and removes any disturbance from objects that cause only amplitude variation of the light.

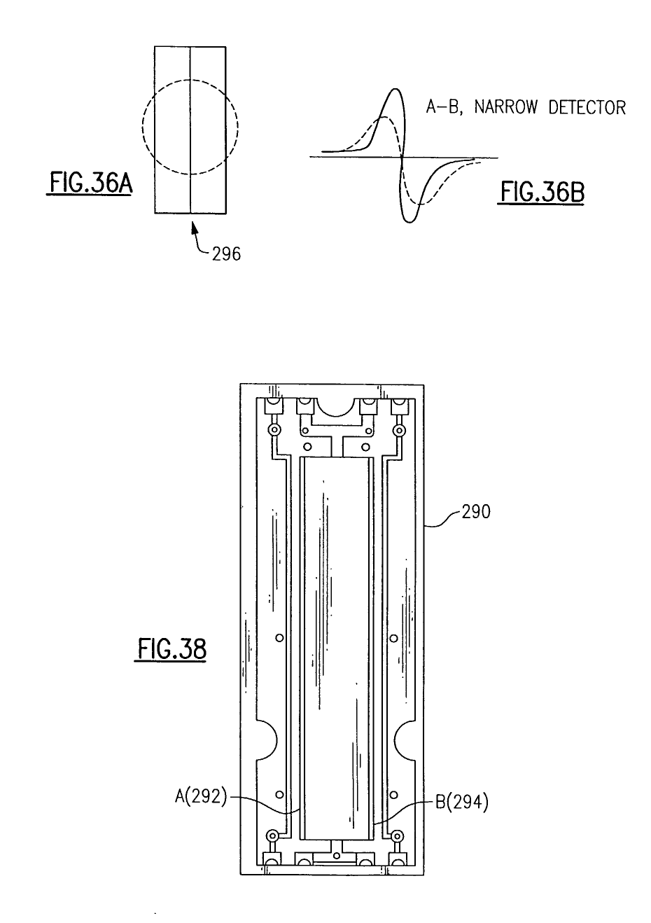

When the extent (width) of the detector is greater than the NA, the two detector outputs can be summed for use on other assay types, such as absorbance variations. However, there is an advantage in making these segments narrower than the NA. FIG. 36A shows such a detector embodiment 296. The advantage is that the signal from cells is greater than the possible signal from objects that have no lensing function. FIG. 36B is an A−B plot that shows the higher signal of the cell (solid line) versus the signal from other objects (dotted line).

By extension, utilizing a pair of small inner segments and a pair of outer segments that cover the whole NA allows appropriate summing of signals to cover both eventualities, as shown in FIG. 37A. Detector 298 comprises left segment 300, center segment 302 that can be optically split and right segment 304.

In another embodiment, a special split detector is divided into four segments as shown in FIG. 37B. Detector 306 has four segments A, B, C and D. It is used in the situation where frequency response of a long detector (˜30 μm) may be too slow for imaging but yet suitable for colorimetry. For example, the imaging done in common CD4/CD8 assays uses only a limited radius measurement range.

Detector 306 is suitable for providing a high frequency response over this shorter radial measurement range. Its shorter segments A and B generate signals A−B suitable for S-curves needed in certain types of cell imaging. A and B are about 10 μm in this embodiment. On the other hand, signal of (A+C)+(B+D) covers the entire radius of the disc and is suitable for other assays that may not need the high frequency response. The speed of the longer segments of the long detector is high enough. Finally adding all the segments together gives a signal that is suitable for colorimetry.

The idea can be generalized for the long split detector where multiple segments in the radial direction can be made covering different high frequency requirements needed for different types of assays. Signals from different segments can be summed to recover the signal detected along the original length of the long split detector.

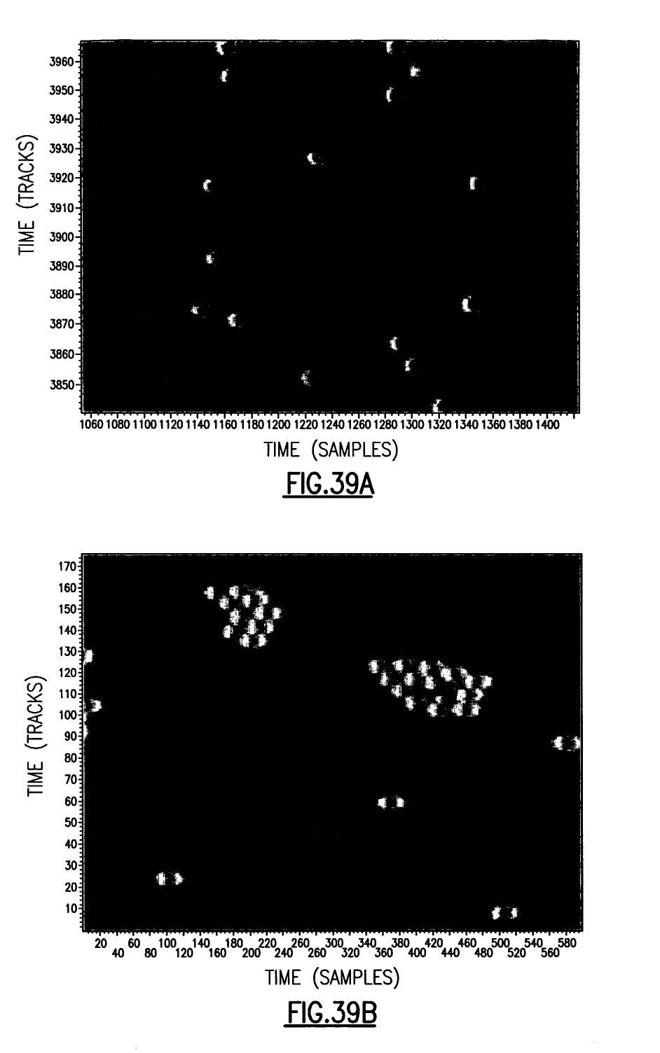

FIG. 38 is an illustration of a split detector mounted on a PCB 290 according to one embodiment of the present invention. It has two separate detectors A (292) and B (294). According to this embodiment, each detector is 2.5 mm wide and 31 mm long with a 50 μm gap between them. Test results show that the split detector produces the lowest background noise seen in the multi-element detectors. The result is that, in the analog signal, a clear and distinguishable S-curve is produced when the incident beam passes over a spherical investigational feature. FIGS. 39 through 42 are various slides of images captured using the split detector discussed supra.

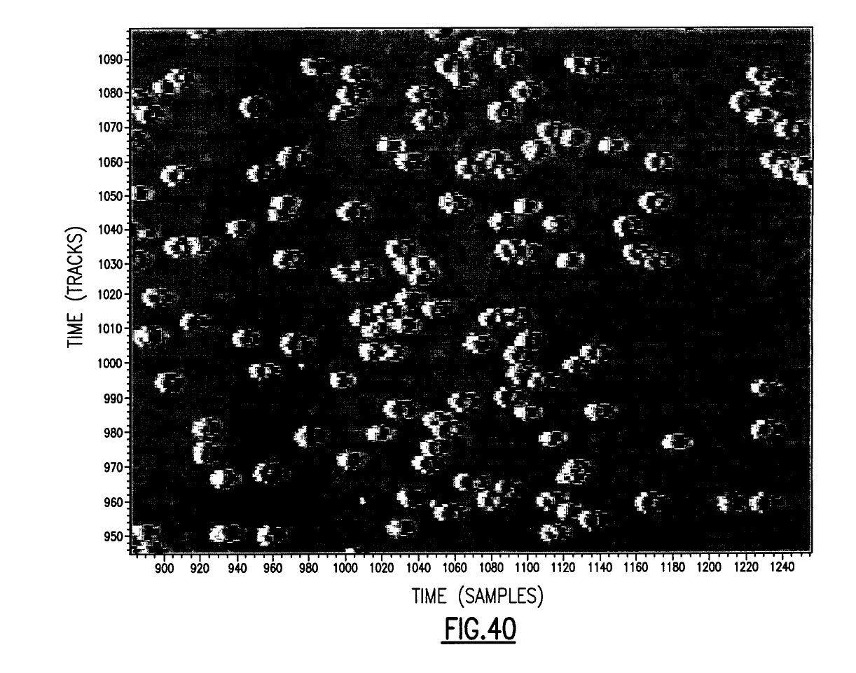

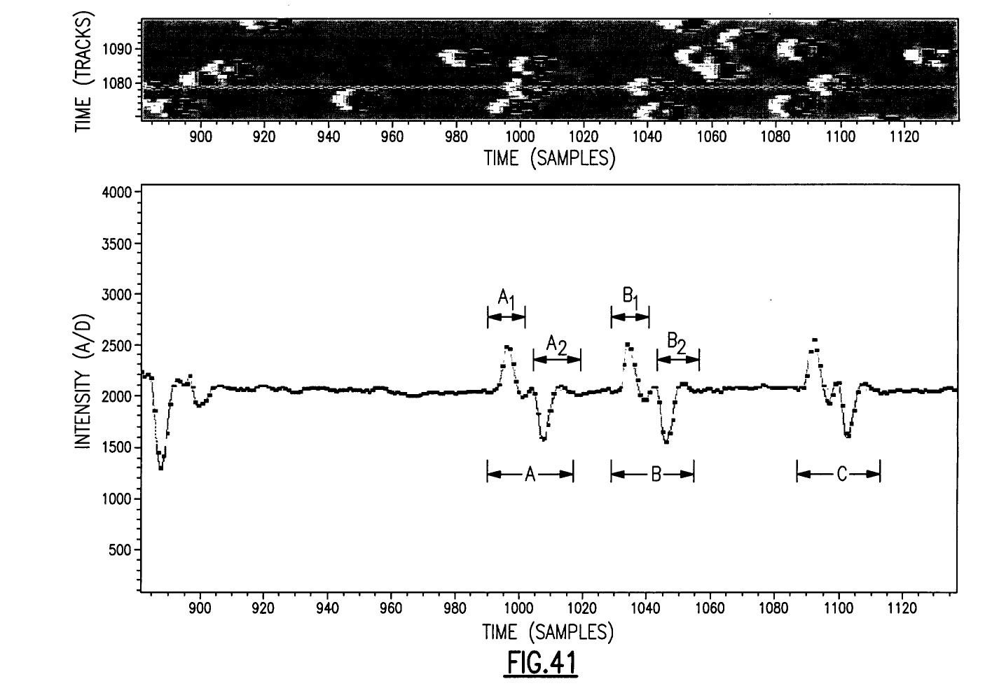

FIGS. 39A and 39B illustrate two such images. FIG. 39A is an image of white blood cells. FIG. 39B is an image of 10 micron beads, which are spherical polystyrene. Glass (or metal balls) to which biological substances get attached are potentially detectible objects as well. FIG. 40 is an image of red blood cells as they pass under the split detector. Note the bright and dark “half-sphere” images for each cell. FIG. 41 shows images of red blood cell signals on the top half of the figure, and a corresponding graph illustrating the A/D intensity of the red blood cell signals. It can be seen from the graph that the S-curve signal intensity is seen whenever the detector encounters a red blood cell. Since red blood cells are shaped with a dimple in the middle (or doughnut shaped), there is a pair of signal spikes (e.g. A₁ and A₂) whenever a red blood cell is encountered. The first part of the S-curve of the pair is indicative of the laser detecting a red blood cell from left to right up to the point of the dimple in the center of the cell. The portion on the graph between A₁ and A₂ is the distance of the dimple. In the graph, the area marked by A, B and C is where red blood cells were encountered.

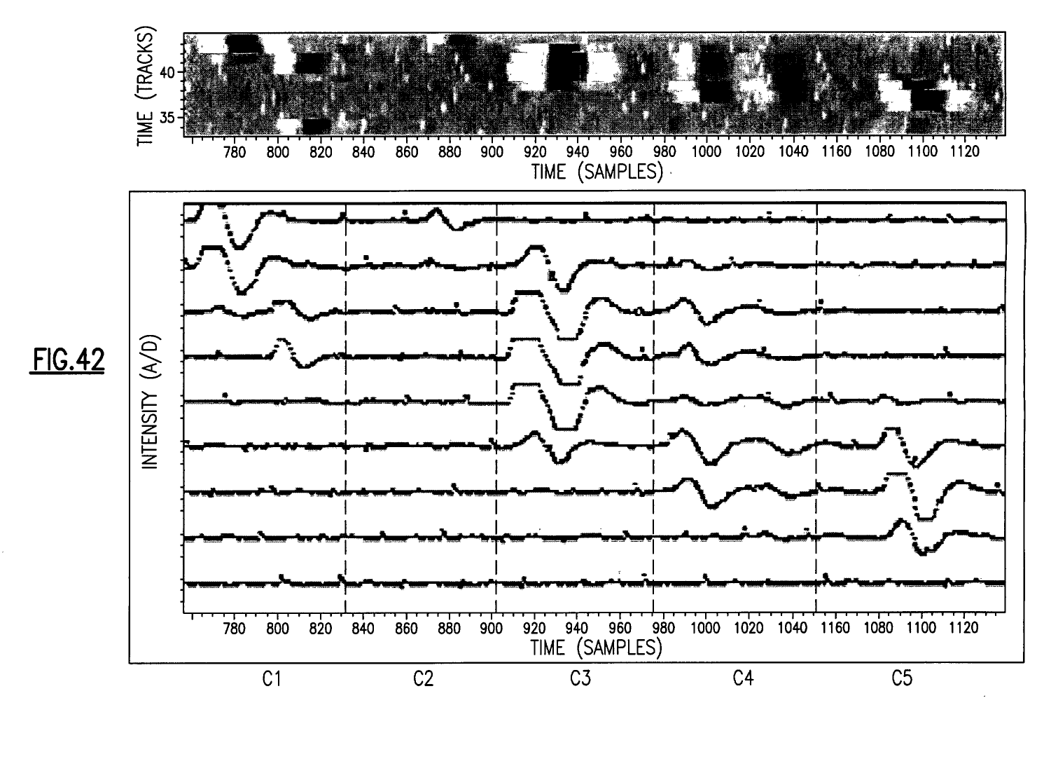

FIG. 42 illustrates, on the top, half images of white blood cells and platelets. The bottom half of FIG. 42 illustrates a graph that shows a series of signature S-curves whenever a white blood cell or platelet is encountered by the detector. If the graph is vertically divided into 5 columns to indicate 5 areas where the S-curves are noticed, and if they are numbered C1 through C5 from left to right, then C1, C3, and C5 have S-curves more prominent than the S-curves in C2 and C4. The more prominent S-curves are indicative of the presence of white blood cells, while the less prominent S-curves are indicative of platelets. A threshold can be set in hardware, based on the data in this graph, that allows detection of the locations of white blood cells. Similarly a different threshold set in hardware can check for platelets.

Asymmetric Detectors

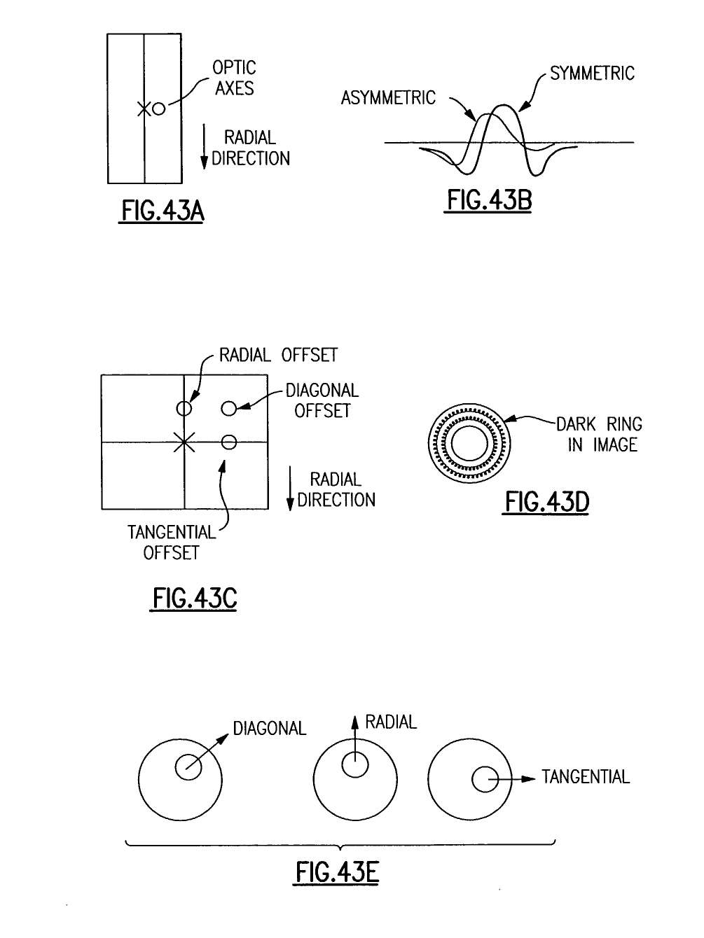

The detector configurations described are aimed at making cells, beads and other reporter particles and systems distinguishable. Since the imaging mechanism of cells is very different from other particles, the effect of placing the detector asymmetrically with respect to the optical axis also leads to distinguishable signals. For example, if a square detector is moved perpendicular to the long axis of the detector (i.e. along a tangent to the disc), then the signal becomes asymmetric. This is calculated in Appendix A—‘Imaging of a Bio-Compact Disc, pt I’, section 6.3. This asymmetric pattern is readily distinguished from that from other objects by image analysis. Exactly the same asymmetric pattern results from imaging with a long detector. Displacement of a square detector in the radial direction also results in an asymmetric signal, only this time with the axis of symmetry being radial. FIG. 43A shows a detector where the optic axis is off-center. The detector is oriented in a radial direction. The corresponding signal is shown in FIG. 43B. The plot of FIG. 43B shows that the difference in signal shapes between an asymmetric and a symmetric signal. FIG. 43C shows three different types of asymmetry that can be created. There is radial offset, tangential offset and diagonal offset. FIG. 43D shows the image of the cell without offset. FIG. 43E shows the images of the cell in the three different types of asymmetry.

In general, asymmetric positioning of a detector will result in corresponding asymmetry in the image, which is distinguishable from the effect on objects that do not have the lensing/deflecting properties of spherical particles.

BCD Analyzer

The production of clear and distinguishable S-curves that comes from the usage of various segmented element detector embodiments enables cell counting to be conducted in hardware. A major draw back in prior art software-based cell counting methods is that they generate large files of data. Often a large percentage of the stored data files does not contain cell data. Furthermore, processing these data files as a second step that cannot take place until data collection is complete causes the assay start-to-finish time to be quite large.

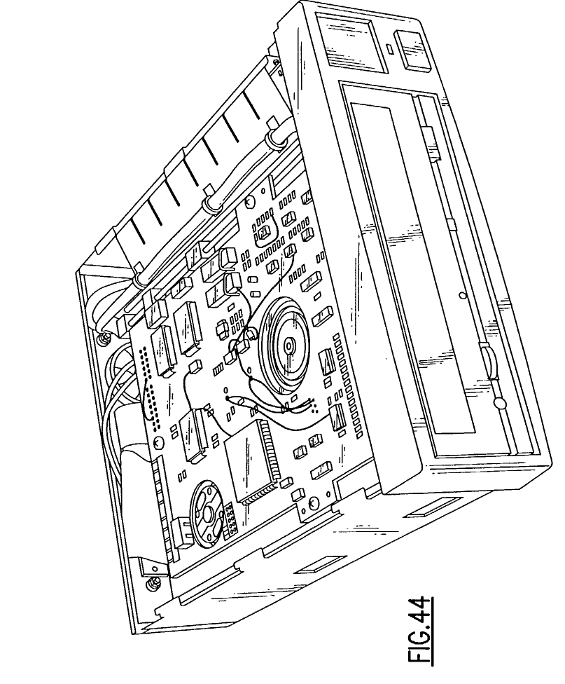

An embodiment of hardware cell counting and analytical processing is called the biological compact disc (BCD™) Analyzer. The BCD™ Analyzer shown in FIG. 44 is a hardware embodiment that combines analytical hardware processing circuitry and optical drive component into a single unit. The BCD™ Analyzer performs cell counting in hardware and saves only the results that are needed for the present test or experiment. The counting of cells is done as they pass through the laser beam, which generates immediate results. The BCD™ Analyzer accepts a wide variety of optical bio-disc embodiments described in the present invention.

The BCD™ Analyzer seen in FIG. 44 has several cost saving features when compared to the embodiments that require hardware comparable to a desktop computer (e.g. the embodiment shown in FIG. 27). The BCD™ Analyzer needs just an 8-bit microprocessor, an FPGA, 512 k RAM, an inexpensive A/D converter and support circuitry. The main reason that BCD™ Analyzer can employ simplified hardware components is that S-curves are now easily distinguishable and converted into digital pulse trains. These pulse trains can be analyzed by digital logic circuitry in real-time.

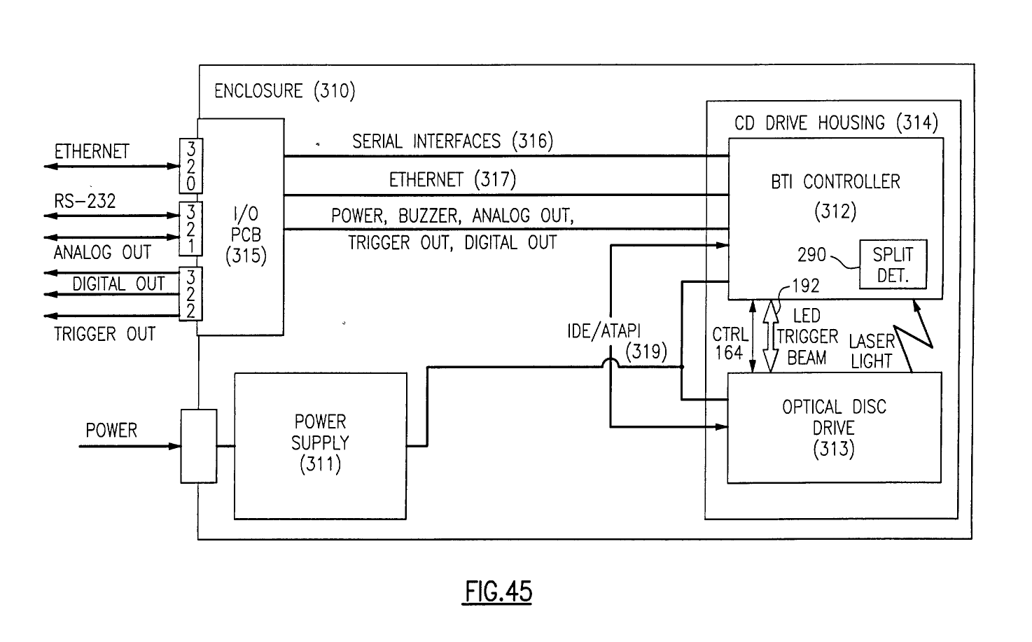

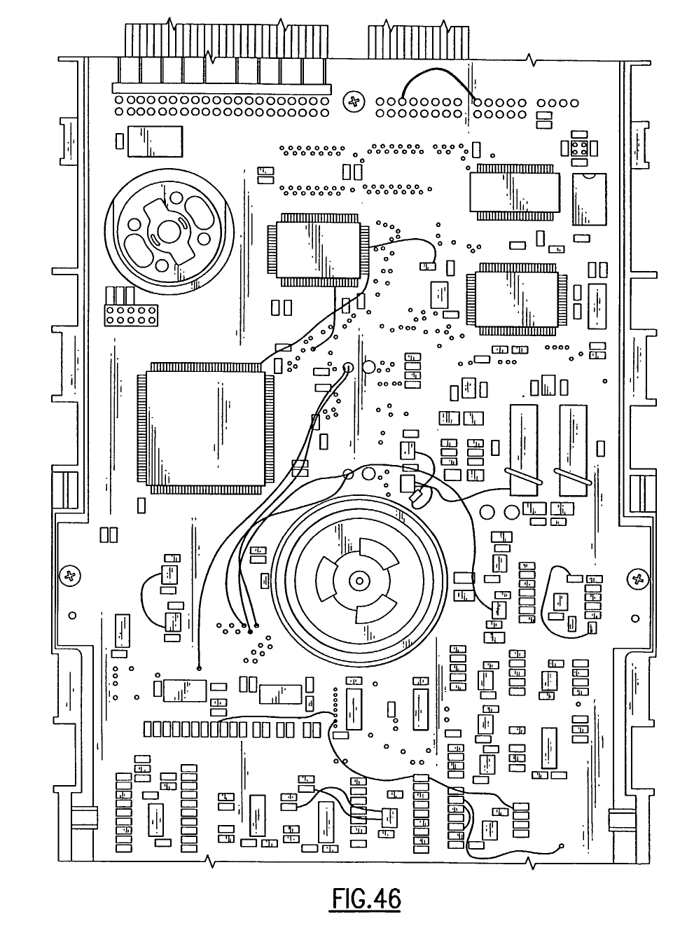

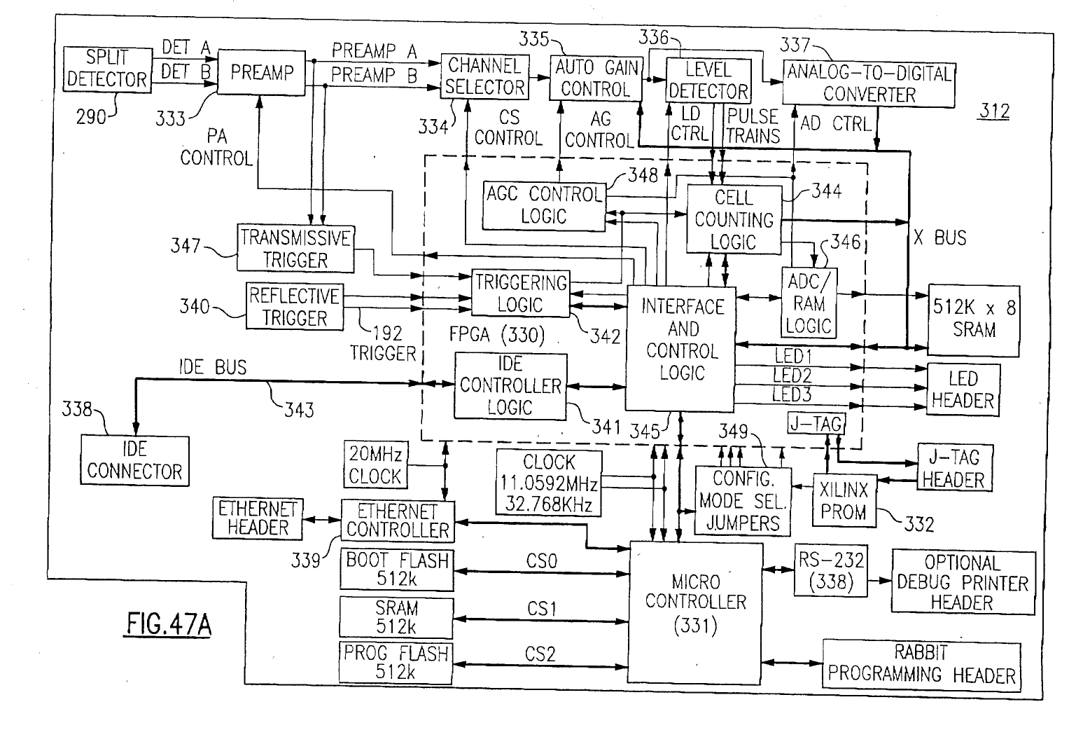

FIG. 45 is a block diagram that illustrates the architecture of the BCD™ Analyzer shown in FIG. 44. Enclosure 310 houses power supply 311 that supports BTI controller 312 and optical disc drive 313 housed within the optical drive housing 314. There is an IDE/ATAPI interface 319 between the BTI controller 312 and the optical disc drive 313. BTI controller 312 also has serial interfaces 316, Ethernet connection 317, and other connections such as power, buzzer, analog out, trigger out, digital out, etc to I/O printed circuit board (PCB) 315. I/O PCB 315 has several ports or controllers such as 320 for an external Ethernet connection 321 for a RS-232 connection, and 322 for the analog out, digital out, and trigger out connections. Ethernet is the standard connection method with a Web browser being the standard user interface. The analog output is for assay development work and debugging problems with the unit. FIG. 46 is an illustration of BTI controller 312 housed in optical drive housing 314 shown in FIG. 31. The Ethernet connection allows user from a remove computer to control the functions of the BTI controller and see the results.

BTI Controller

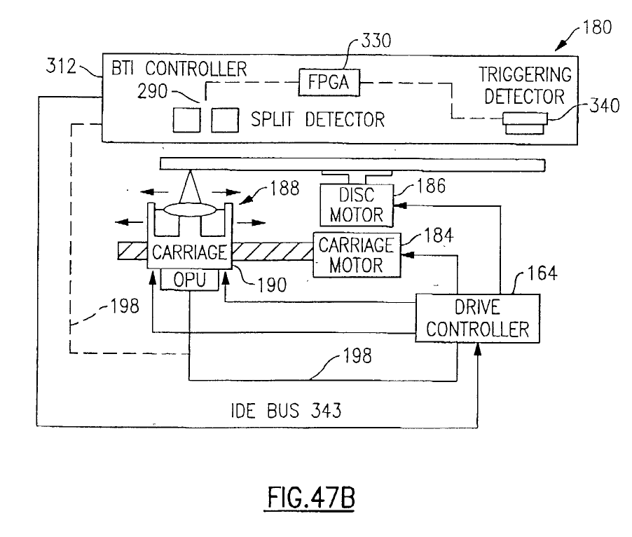

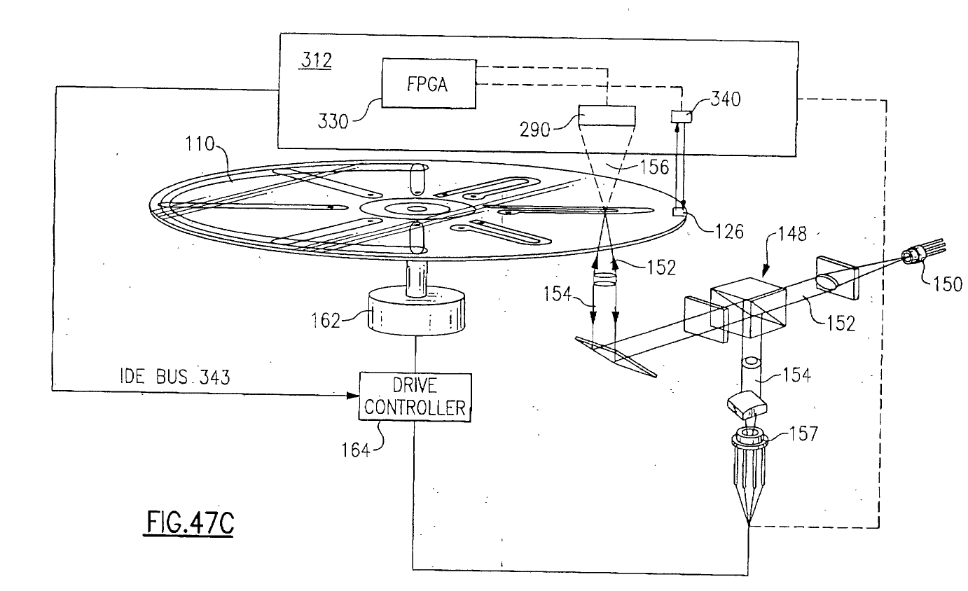

FIG. 47A is a block diagram of the controller illustrated in FIG. 46. It comprises, amongst other components, a Field Programmable Gate Array (FPGA) 330. FPGA 330 interfaces, amongst other components, with micro controller 331, an IDE connector 338, and gain control 335. In one embodiment, the BTI controller can be used as an add-in board that can be fitted into a standard optical disc drive to provide the capability of analyzing biological assay discs (see FIG. 47C).

The processing sequence of the signal is as follows. Signal data from detector A and detector B of split detector 290 is first passed to Preamp 333. Preamp 333 outputs Preamp A and B signals to channel selector 334, which is controlled by the interface and control logic 345 in FPGA 330. The channel selector allows control for selecting detector signal combinations (e.g. A, B, −A, −B, A+B, A−B, B−A). Gain control 335 gets incoming signal from channel selector 334. Gain control 335 is controlled by AGC control logic 348 in the FPGA 330. The signal is then passed to level detector 336 and converted to digital pulse trains for processing by cell counting logic 344. The gain control circuit output also goes to the A/D converter for applications such as colorimetry where voltage levels need to be measured. The ADC is also used during calibration stages to allow automatic setting of offset and gain.

The functions of the various control components described below have been implemented using VHDL (VHIC Hardware Description Language).

In the other parts of the controller, micro controller 331 also interfaces with, amongst other components, RS-232 338 (also seen in FIG. 45), and an Ethernet controller 339 (also seen in FIG. 45). Reflective trigger 340 and transmissive trigger 347 detect triggers embedded on optical bio-discs and interface with triggering logic 342 within FPGA 330. Transmissive trigger 347 receives the Preamp A and Preamp B signal while reflective trigger 340 is an emitter/detector that detects the presence of trigger marks on an optical disc. Triggering Logic 342 extracts the trigger 0 from the selected triggering input signal to enable the microcontroller to determine the number of possible assays per disc. It then counts the total number of assays to be run on the assay disc and sets the timing accordingly.

IDE controller logic 341 controls IDE bus 343, which is connected to an IDE connector 338. IDE controller 338 connects to an IDE/ATAPI optical bio-drive. The IDE Controller Logic module 341 interfaces the microcontroller to the optical disc reader. The address bus A of the microcontroller is decoded and gated with other 10 control to provide various IDE control signals.

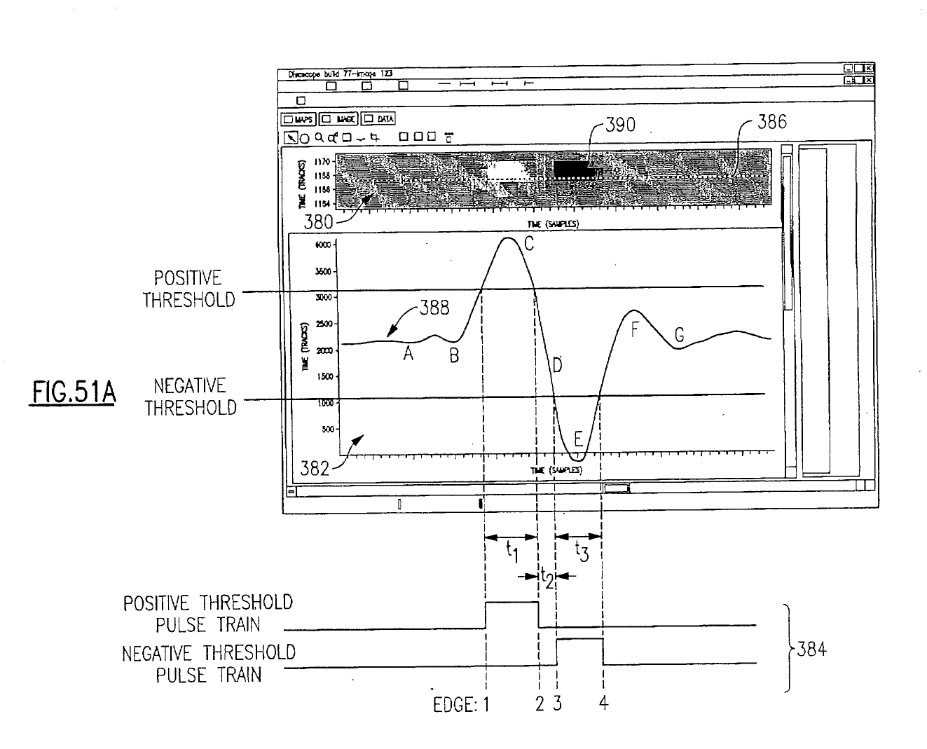

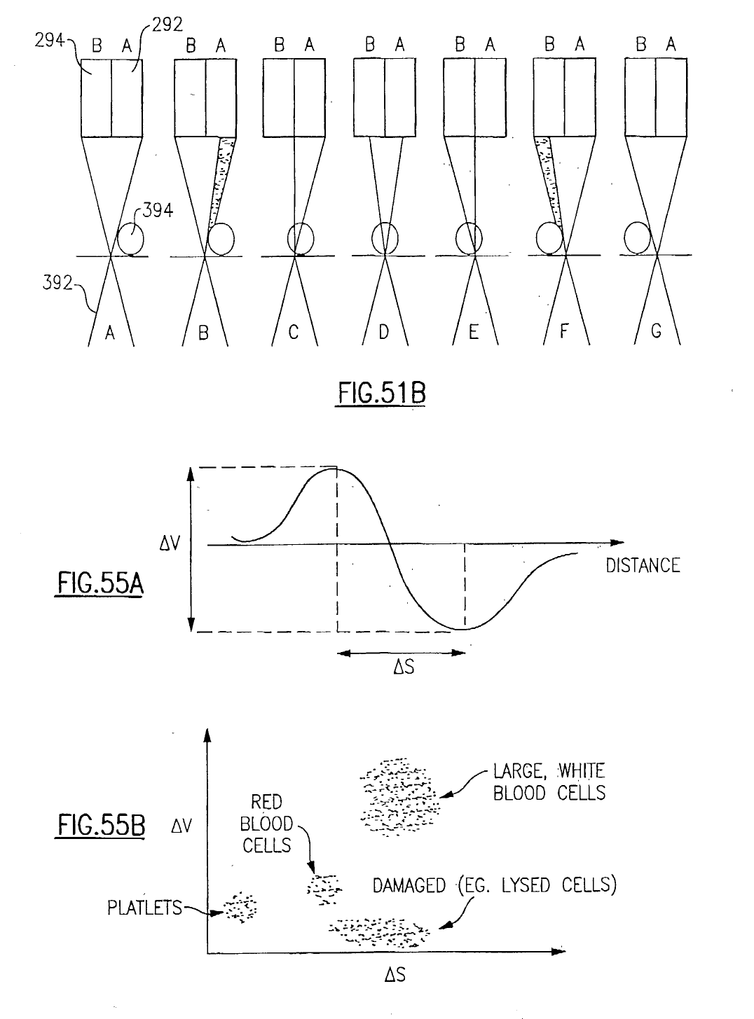

The AGC Control Logic module 348 reads the digitized data of the detector signal to determine the optimum gain for the detector amplifier. This ensures that the signal remains within an optimum range for further processing. AGC 348 is used to cause the difference signal (e.g. from split detector A−B) to be of a consistent peak-to-peak voltage from drive to drive and from disc to disc. It is used by scanning an area of the disc that has known light refracting properties. While scanning this area, the AGC circuit adjusts the gain such that the peak-to-peak voltage is a predetermined value. This will allow the threshold crossing circuit to work with signals at the same level each time. Threshold crossing mechanism is implemented in level detector 336 and is further described in conjunction with FIG. 51A.

Also, an automatic offset control (from the interface and control logic 345 to preamp 333) is used to insure that the voltage level coming from each detector is the same in the absence of any light. This allows the subsequent circuitry to amplify the signal without amplifying a common DC bias.

FPGA 330 controls the following different functions: Microcontroller Interface and Control Logic 345, IDE Controller Logic 341, Triggering Logic 342, AGC Control Logic 348, Cell Counting Logic 344, and ADC/RAM Control Logic 346.

All digital logic is performed in FPGA 330, which is configured with a default configuration by the microprocessor at power up. Assay specific FPGA configurations are then loaded into the FPGA after an assay disc is inserted into the BCD™ Analyzer. The FPGA can then perform a variety of functions required by the particular assay on the inserted disc including triggering the digital logic (342), interfacing with the IDE, microprocessor, and managing a dedicated RAM (346), performing cell counting logic (344), and controlling the A/D converter. The ADC/RAM Control Logic module 346 generates address and control lines to allow the microcontroller to access the on-board RAM.

The usage of an FPGA in the present invention is a tremendous advantage. To perform many of the necessary functions involved in the analysis of optical bio-discs, a digital logic device can be used to carry out many of the tasks that have previously been done by software. An FPGA is just such a logic device. FPGAs allow in-system configuration and can be configured with extremely complex digital circuits that run very fast. Tasks such as cell counting can be performed in real time with the results being available the instant the track around the disc is completed and with no microcontroller overhead.

The reconfigurable nature of an FPGA allows tremendous flexibility. Each disc/assay combination can utilize a different digital control and processing circuit design. The configuration is accomplished with simple binary files that can be loaded by the microcontroller as needed. The user interface can be used to load updated FPGA configuration files. Configuration files can even be mastered into the optical discs so that each different type of assay can have its own digital circuit design.

This reconfigurability also makes system design improvements very easy to deploy into the field. Product upgrades can happen automatically by distributing discs with the latest design configuration files that the microcontroller will automatically upgrade with upon first use of the new discs.

Micro Controller 331 module interfaces the microcontroller to the various control logic blocks. The a dress bus A of the microcontroller is decoded and gated with other 10 control signals to read or write a number of registers in the FPGA. These registers are used to control other logic blocks of the BTI Controller 312 or return data and/or status to the microcontroller from these logic blocks.

Compared to the schematic of FIGS. 25 and 27, it can be seen that BTI controller 312 is serving the function of both TAD (trigger, amplifier, detector) card 180 and CPU 196, which performs signal data processing as well as drive control. Just as TAD 180 comprises top detectors 158 and trigger detector 160, BTI controller 312 comprises split detector 290 and reflective trigger 340. BTI controller 312, like TAD 180 is also located close above the disc with the detector mounted directly above the objective assembly.

FIG. 47B shows the resulting schematic diagram with BTI controller 312 inserted into FIG. 20. BTI controller 312 is mounted above the carriage assembly 190. IDE controller logic 341 controls drive controller 164. Quad detector signal 198 from optical components 188 can be optically tapped off and fed into BTI controller 312. Optical components 188 are mounted on a carriage assembly 190 that is driven by a carriage motor 184, and the disc is driven by the disc motor 186. The carriage assembly 190 includes an optical pick-up unit (OPU). Drive controller 164, which is controller by IDE controller logic 341, drives the two motors. Unlike TAD 180 which fed amplified detector signals to other off-TAD components such as an ADC, the signals from spilt detector 332 and reflective trigger 340 are handled by components within BTI controller 312 (see FIG. 47A). The dotted line to FPGA 330 signifies that other components are involved in the processing of the signals from the reflective trigger 340 and split detector 332. Thus BTI controller 312 contains/combines the trigger, amplifier and detector functions with the signal data processing and optical drive controller functions normally performed by a CPU.

FIG. 47C further shows how BTI controller 312 interacts with optical disc assembly. Again BTI controller 312 comprises split detector 290 and reflective trigger detector 340. Shown also in the figure are optical components 148, a light source 150 that produces the incident or interrogation beam 152, a return beam 154, and a transmitted beam 156. Transmitted beam 156 is detected, by a split detector 290, and is also analyzed for the presence of signal agents. Optionally the signal from bottom (quad) detector 157 can be tapped off and fed into BTI controller 312.

As shown in FIG. 47C, triggering mechanism is needed to control the start and end of beam analysis. Hardware trigger mark 126 is preferably disposed at an outer periphery of the disc. Reflective trigger detector 340 and triggering logic 342 provides a signal indicating when trigger mark 126 has reached a predetermined position with respect to an investigational feature of interest. As mentioned before, another embodiment uses signal detected by the split detector and fed via the preamp to the transmissive trigger 347. Regardless of how the signal is acquired, it is processed through triggering logic 342 to synchronize signal data processing that takes place in FPGA 330. In an example case, the synchronization is achieved by having trigger mark 126 placed just prior to a sector in bio-disc 110 containing investigational structures.

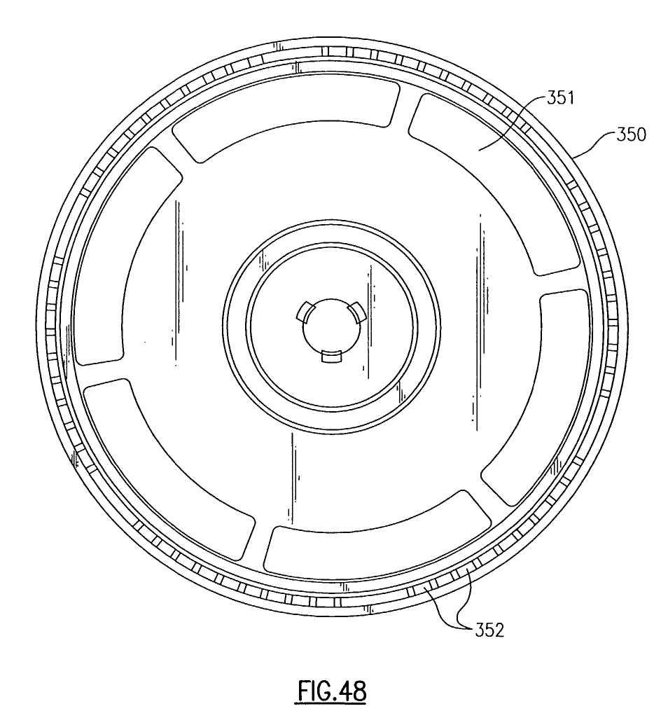

FIG. 48 is one embodiment of the disc used in the present invention, where disc 350 has 6 sample channels (351). Since each channel has 10 capture spots/trigger marks (352), there are 60 trigger marks on the disc. These capture zones are at the same radius of the disc to facilitate simultaneous analysis.

Signal Processing from the Detector Signals

The signals from the detector segments give distinctive patterns. There are two ways of processing them: firstly analog processing (such as summing or subtracting segments from each other) followed by digital signal processing, or digital processing directly on the segment outputs. There may be automatic gain controls, threshold levels etc. used in the required analog to digital conversion. BTI controller 312 shown in FIG. 47A is responsible for performing all of such processing of signals.

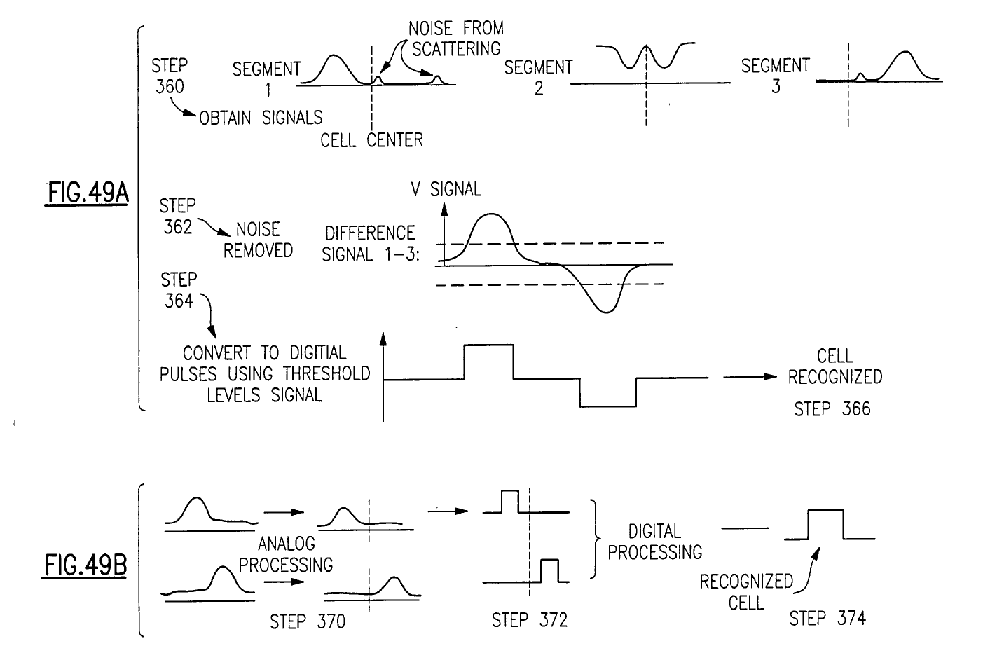

FIG. 49A shows a simple process for signals from a detector configuration as shown in FIG. 32A. First in step 360, the signals from segments 1 through 3 are obtained. Then in step 362, segments 1 and 3 are subtracted from each other. This has the advantage that any light derived from (symmetric) scattering from objects other than cells will be subtracted from the difference signal. Then threshold levels can be applied in step 364 to give a pulse train that can be recognized in the digital domain.

In FIG. 49B, the analog to digital conversion is done on the segments directly in step 370. Then digital processing is done on the multiple digital pulse trains in step 372. Cell recognition is done in step 374.

The key to the digital domain processing is that the pulses arrive at the detector segments in a specific order, and detection of pulse trains containing this ordering gives an excellent identification method. Many digital methods are available for doing this.

Associated Issues with Processing

When a large cell (˜10 μm) lies on a disc, the light spot passes over it multiple times. Image recognition can then be used to distinguish such cells. If the electronics involved in image storage and processing is to be avoided, and event counting methods such as those described above are used to recognize cells when the beam passes over one, then it is necessary to distinguish the multiple passes to avoid multiple counting. Methods to achieve this may be:

1. Digital. The cells recognized by event counting are tagged either by their time of occurrence or some other method of denoting their location, and the data stored. Since relatively few cells are met during a single pass—below 100—the data storage size required is limited. Then during successive passes, events counted at the same location may be ignored.

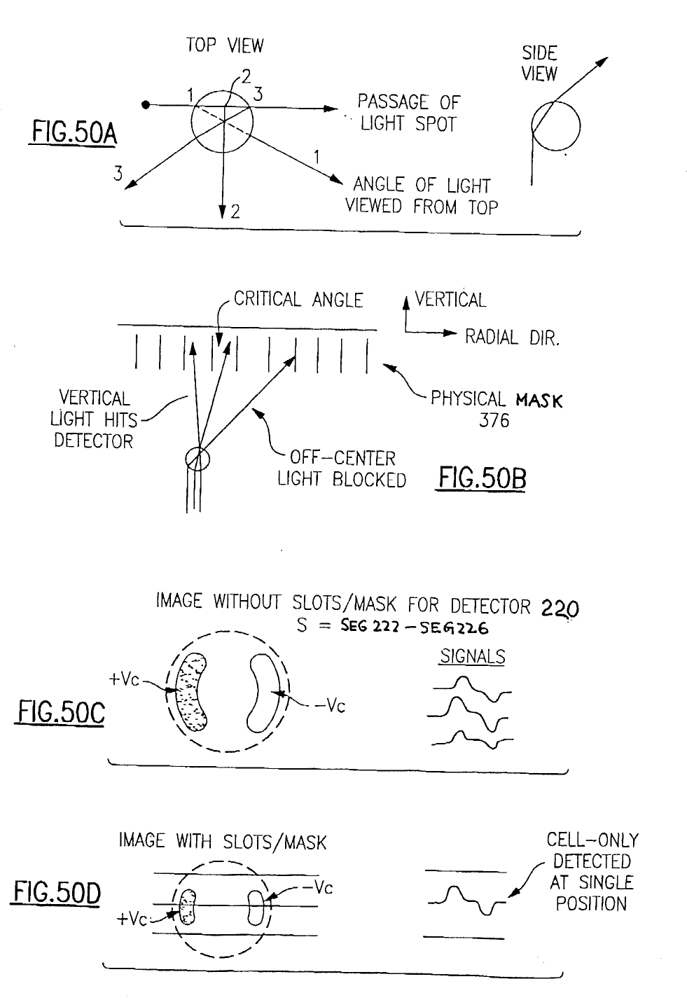

2. Physical. Light passing off-center through a sphere is deflected radially as well as tangentially. FIG. 50A offers both a top view and a side view. The light ray therefore has an angular component in the radial direction, and may be physically filtered by a mask such as ‘slots’ 376 shown in FIG. 50B. The dimensions of the slats may be varied such that the signal is only detected when the focused light spot accurately traverses the centre of the cell. There are many physical configurations of such a mask 376 (e.g. tubes), but the physical principle is that it blocks light with radial component making more than a critical angle with respect to the vertical. FIG. 50C shows the image produced without slots for the detector embodiment shown in FIG. 32A. FIG. 50D shows the image produced with slots for the detector embodiment shown in FIG. 32A.

Signal Processing in Controller

BTI controller 312 contains programmed methods for recognizing cells in incoming signal data. FIG. 51A and FIG. 51B provide pictorial explanation of such methods. 51A is a cell image and its accompanying S-curve voltage plot and derived pulse trains discussed above obtained using split detector 290. Recall from FIG. 29 that split detector 290 has two detectors, detector A 292 and detector B 294. Graph 382 is a plot of resultant voltage of taking A minus B (y axis) versus time (x axis). Graph 380 on top shows the imaged data of cell 390 with the time axis aligned with graph 382. Dotted line 386 shows the physical reading location of A−B voltage graph line 388.

FIG. 51B is presented to explain the S-curve shape of graph line 388. FIG. 51B presents a diagram time-line depicting the interaction among split detector 290, incident beam 392 and an example investigational feature 394 such as a cell. At time “A”, incident beam 392 is unaffected by investigational feature 394. The “A” label in graph line 388 of FIG. 51A corresponds to this scenario. At time “B”, incident beam 392 is focused directly below the leading edge of investigational feature 394. A fraction of the light toward detector A 292 is blocked by the edge of investigational feature 394. This corresponds to the slight dip on graph line 388 marked “B”, since graph line 388 represents A−B and the signal on detector A 292 is now lower. At time “C”, the optical bio-disc has spun to a point where investigational feature 394 is positioned in the direct path of incident beam 392 yet feature 394 is not centered over the beam. The lensing effect takes place where investigational feature 394 is acting as a lens to focus and refract incident beam 392 directly onto detector A 292. Detector A 292 receives the focused (and bent) incident beam 392 and generates a very high signal voltage. Detector B 294 does not detect any of incident beam 392. Thus in FIG. 51A, “C” marks a high peak beyond the positive threshold on graph line 388. At time “D” of FIG. 51B, the optical disc is spun further so that incident beam 392 is focused evenly between detector A 292 and B 294—feature 394 is centered above incident beam 392. Graph line 388 at “D” is at 0 since the two signals cancel each other. At time “E”, incident beam 392 is focused and bent by investigational feature 394 onto detector B 294. Detector A 292 is dark. Thus in graph line 388, the graph line at “E” has dipped into the negative threshold since the voltage signal of B is high and A is low. At time “F”, the reverse of the time “B” scenario takes place and a bump in the A−B difference signal is detected. Finally, at time “G”, the investigational feature 394 passes by the incident light and the signal returns to 0 since both detectors have equal signals.

Thresholding

Level detector 336 (FIG. 47A) comprises threshold crossing circuit that helps perform a conversion of the signal from analog to digital. The conversion is performed by converting the A−B analog voltage to digital pulses. The threshold crossing circuit is comprised of two programmable voltage sources and two threshold comparators. Each voltage level is independently controllable. Since the AGC circuit assures a consistent peak-to-peak input signal to the threshold crossing circuit, the thresholds can be set to known values that give optimum recognition results.

In one embodiment, the positive and negative thresholds in graph 382 can be set in controller hardware before starting recognition. The thresholds are set depending on the kind and type of investigational feature that needs to be detected. The positive and negative threshold can be set independently. There are pulse trains or TTL signals fed to the FPGA 330 by level detector 336. There two pulse trains, one for the positive threshold and one for the negative threshold. As shown in graph 384 of FIG. 51A, whenever graph line (A−B) 388 crosses the positive threshold, a pulse is generated in the positive threshold pulse train. The same goes for the negative pulse train. Whenever graph line (A−B) 388 crosses the negative threshold, a pulse is generated in the negative threshold pulse train. The usage of signal A−B filters out any background light that does not bend.

S-Curve Events

From the timing information such as lag time “t2” between the high “t1” of positive threshold pulse train (edges 1 and 2) and the high “t3” of negative threshold pulse train (edges 3 and 4), the controller can assert if an S-curve has been generated. Since each type of investigational feature generates different “t” times, the length of the “t” times provides a valuable tool to detect specific types of investigational features. For instance, red blood cells have a long “t2” due to the dimple in the middle of the cells, their “t1” and “t3” may be small as compared to, for example, those of while blood cells.

FIG. 52B illustrates a state machine method that takes advantage of such timing information to recognize investigational features. Edges 1, 2, 3, and 4 are used to control the state machine-based recognition method that is within the FPGA 330. In one embodiment, the recognition method is implemented in cell counting logic 344.

The state machine works as follows. For each state, there is a time window, defined by a minimum and a maximum time boundary (minimum edge and maximum edge), within which edges should occur for the state machine to move from that state to the next. Because the arrival of edges is dependent on the size and shape of the objects that generate the detected signals, setting minimum and maximum time boundaries distinguish investigational features from irrelevant objects such as dirt particles and scratches on the disc. Setting the time boundaries can also distinguish a particular type of investigational feature (e.g. red blood cells) from other features in the biological substance in the assay.

In the example shown in FIGS. 52A and 52B, the state machine begins in state0, and looks for edge 1. If edge 1 is not detected then the state machine does not leave state0. The state machine goes to state1 if edge 1 is detected. While in state1, the state machine looks for edge 2. If edge 2 occurs within the valid time window for t1, then the state machine moves from state1 to state2, and so on down the other states. The state machine remains in state1 if edge 2 has not yet arrived and the maximum time boundary for t1 has not yet passed. If the maximum time boundary for t1 occurs or edge 2 shows up before the minimum t1 time boundary, then the state machine goes back to the initial state (state0). In other words, the state machine progresses if the edges occur within their respective time windows based on the thresholds. In state2, the state machine remains in state2 as long as edge 3 has not yet arrived and the maximum time boundary for t2 has not yet passed. If the maximum time boundary for t2 occurs or edge 3 shows up before the minimum t2 time boundary, then the state machine goes back to the initial state (state0). Likewise for the t3 interval. Finally, when the state machine leaves state3 by a valid edge 4 occurrence, an S-curve event bit is set in memory.

Besides being based on the timing information of FIG. 51A, the triggering of the S-curve event mentioned above can be based on other parameters also. For example, the detection of the S-curve event can be based on another machine state, detected intensity of the substance, or other parameters.

The state machine illustrated in FIG. 52B is but one of many other configurations that are possible using the present invention. If the biological substance is tested for the presence of more than one element in it then there could be more than one branch after certain conditions are met, and a more complex state machine tree is obtained. For example, consider an assay where detection is needed for both white blood cells and red blood cells. Branching stages can be added such that the state machine can go down a branch based on the timing of the edges. In other words, the user can input different thresholds depending upon the number of elements that need to be detected in a given biological substance.

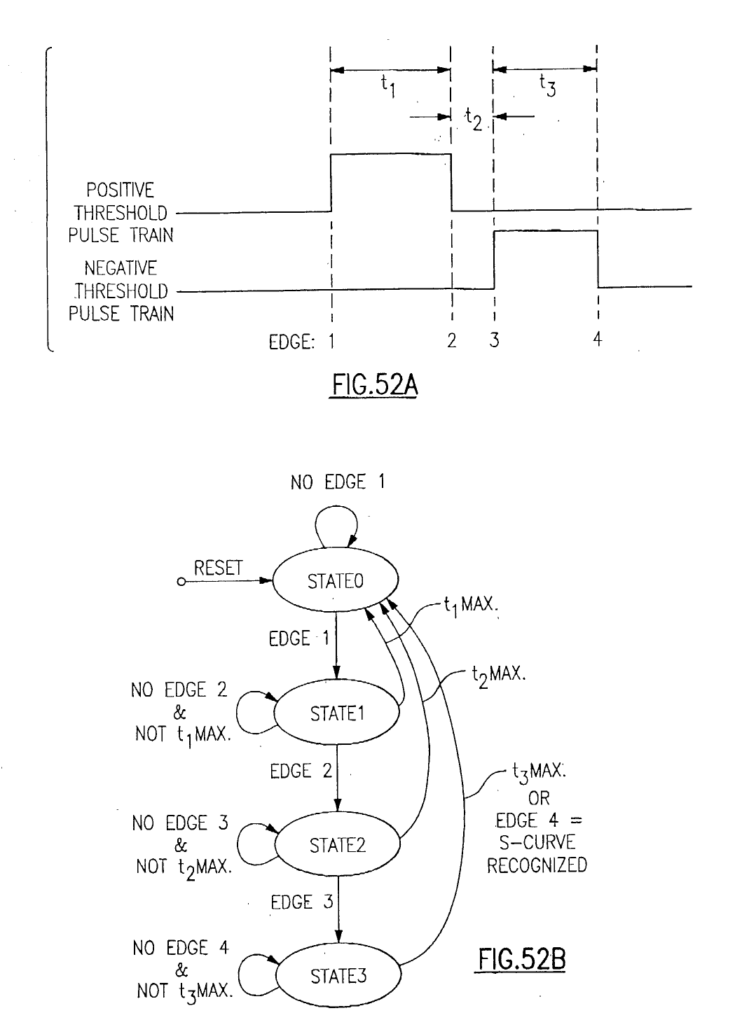

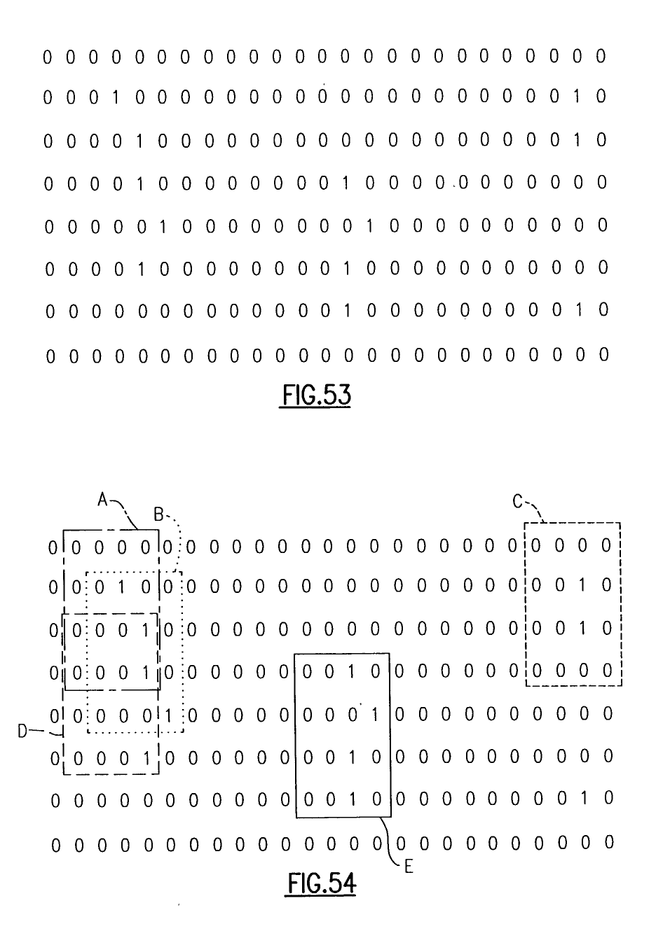

FIG. 53 illustrates a grid comprising of 1's and 0s, which is an example S-curve events being stored in RAM based on the results of the state machine method of FIG. 52B. The memory map columns in FIG. 53 correspond to 100 ns intervals during S-curve recognition, and the memory map rows correspond to disc tracks stored in a circular buffer. In other words row 1, corresponds to track 0, 8, 16, etc. Similarly row 6 corresponds to track 5, 13, 21, etc. Thus at any given time, the RAM stores the state machine detection results of last eight tracks that were read. Thus a 1 represents an S-curve recognition event detected at that particular point in time on that particular track.

One skilled in the art will appreciate that the timing intervals of 100 ns as column indicators and disc tracks as row indicators are just one of many other parameters that can be used as both column and row indicators. In this particular embodiment, the memory consumption of the RAM uses 2 mm length of track or 3846 bits, where the last 8 tracks are stored in a circular buffer. So for sixteen 2 mm capture zones per revolution, there are (3846*8*16)/8=61536bytes=64K, which is a trivial amount when compared to the hundreds of megabytes required by prior art methods. Often time these methods store imaged data or other data representative of the entire target area on the optical disc.

The grid in FIG. 53 has 1's and 0's because the state machine of FIG. 52B is only detecting a single S-curve event, namely the presence of white blood cells. As explained supra, the user can input more than one thresholds to invoke a S-curve event, in which case the grid may have more than 2 values. For example, if “0” indicates a clear state in RAM, “1” indicates an S-curve event when a white blood cell is detected, “2” indicates a S-curve event when a red blood cell is detected, and if “3” indicates an S-curve event when a platelet is detected, then a RAM memory map may look like:

| | | | | | | | | | | | | | | | | | | | | | | | | | | | |
|---|---|---|---|---|---|---|---|---|---|---|---|---|---|---|---|---|---|---|---|---|---|---|---|---|---|---|---|
| 0 | 0 | 1 | 0 | 0 | 0 | 0 | 0 | 0 | 2 | 2 | 2 | 0 | 0 | 0 | 0 | 0 | 0 | 0 | 0 | 0 | 0 | 0 | 1 | 0 | 0 | 0 | 0 |
| 0 | 1 | 1 | 0 | 0 | 0 | 0 | 0 | 0 | 2 | 0 | 0 | 0 | 3 | 3 | 3 | 0 | 0 | 0 | 0 | 0 | 0 | 0 | 1 | 1 | 0 | 0 | 0 |
| 0 | 0 | 1 | 0 | 0 | 0 | 0 | 0 | 0 | 2 | 0 | 0 | 0 | 3 | 3 | 0 | 0 | 0 | 0 | 0 | 0 | 0 | 0 | 1 | 0 | 0 | 0 | 0 |
| 1 | 0 | 0 | 0 | 0 | 0 | 0 | 3 | 3 | 3 | 0 | 3 | 3 | 0 | 0 | 0 | 0 | 0 | 0 | 0 | 0 | 0 | 3 | 3 | 3 | 0 | 0 | 0 |
| 1 | 0 | 0 | 0 | 0 | 0 | 0 | 3 | 0 | 3 | 0 | 3 | 3 | 0 | 0 | 0 | 0 | 0 | 0 | 0 | 0 | 0 | 3 | 0 | 3 | 0 | 0 | 0 |
| 1 | 0 | 0 | 0 | 0 | 0 | 0 | 3 | 0 | 0 | 0 | 3 | 3 | 0 | 0 | 0 | 0 | 0 | 0 | 0 | 0 | 0 | 3 | 0 | 0 | 0 | 0 | 0 |
| 0 | 0 | 0 | 0 | 0 | 0 | 0 | 0 | 2 | 2 | 2 | 0 | 0 | 0 | 3 | 0 | 0 | 0 | 0 | 2 | 0 | 0 | 0 | 0 | 0 | 0 | 1 | 1 |
| 0 | 0 | 0 | 0 | 0 | 0 | 0 | 0 | 2 | 2 | 2 | 0 | 0 | 0 | 3 | 0 | 3 | 0 | 0 | 2 | 0 | 0 | 0 | 0 | 0 | 0 | 1 | 1 |

and so on. The above RAM memory map corresponds to 3 concurrent events.

Since an investigational feature may cross several tracks on the optical disc and trigger multiple S-curve events, further logic is needed to determine how to interpret a memory map similar to that of FIG. 53. For example, a single white blood cell can trigger S-curve events three to five times. In one embodiment, a method called track-to-track correlation matrix is used to correlate multiple instances of S-curve events into a single detection of an investigational feature such as a white blood cell.

FIG. 54 illustrates a track-to-track correlation matrix that operates during the non-sampling time of each revolution. The size of a correlation matrix can vary from 2 to 7 rows and 4 to 8 columns, for example, and is based on the kind of sample, thresholds, and other such parameters. In the figure a 4×4 correlation matrix is used by way of example. The correlation matrix moves across the rows and detects whether there is a correlation among the values within the matrix. The criteria for a positive correlation can be set by the user. In this example, the criteria for a positive correlation is this: a 1 found in each of the four rows in the matrix. Thus, for the example of FIG. 54, matrix E has found a positive correlation of 4 1's within the matrix. This can be said also for matrix B. A positive correlation increments the appropriate investigational feature counter. Once this happens, all values in the matrix are reverted to 0's so they will not be double-counted. In other cases, the criteria may be 3 out of 4 rows with 1s. This strategy may prove useful in counting red blood cells that have a characteristic dimple, which tends to show up as a 0 (non-S-curve event) in its center.

Referring back to FIG. 54, the 4×4 correlation matrix starts from the top left hand corner and moves horizontally across the map. For example, the correlation matrix B encounters four 1's (second row fourth column, third row fifth column, fourth row fifth column, and fifth row sixth column). As the correlation matrix moves across the map and down to the next row it would encounter the same 1's. The clearing of the 1's in correlation matrix B prevents this. The memory map shown in FIG. 54 would actually look like the one shown below once the four 1's mentioned above are accounted for and the correlation matrix moves to the next row:

| | | | | | | | | | | | | | | | | | | | | | | | | |
|---|---|---|---|---|---|---|---|---|---|---|---|---|---|---|---|---|---|---|---|---|---|---|---|---|
| 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 |
| 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 1 | 0 |
| 0 | 0 | 0 | 0 | 0 | 0 | 0 | 0 | 0 | 0 | 0 | 0 | 0 | 0 | 0 | 0 | 0 | 0 | 0 | 0 | 0 | 0 | 0 | 1 | 0 |
| 0 | 0 | 0 | 0 | 0 | 0 | 0 | 0 | 0 | 0 | 0 | 0 | 0 | 1 | 0 | 0 | 0 | 0 | 0 | 0 | 0 | 0 | 0 | 0 | 0 |
| 0 | 0 | 0 | 0 | 0 | 0 | 0 | 0 | 0 | 0 | 0 | 0 | 0 | 1 | 0 | 0 | 0 | 0 | 0 | 0 | 0 | 0 | 0 | 0 | |
| 0 | 0 | 0 | 0 | 1 | 0 | 0 | 0 | 0 | 0 | 0 | 0 | 0 | 1 | 0 | 0 | 0 | 0 | 0 | 0 | 0 | 0 | 0 | 0 | 0 |

, and so on.

Paramertization of S-Curve Counting

From the description above, it can be appreciated that the user can generate different requirements for counting different types of cells. The setting of (1) thresholds in analog-to-digital conversion (FIG. 39A) and (2) the timing windows in the state machines (e.g. t1, t2, t3) can influence the behavior of the event counter. This is advantageous because the counter is programmable to handle various cell types.

A more generalized model is offered in the present invention to guide the setting of these parameters. FIG. 55A offers a plot of the A−B S-curve. Two important parameters ΔV and ΔS are shown. ΔV is the peak-to-peak voltage of the detected signal and can be measured using the ADC (337 in FIG. 47A). ΔS, on the other hand, is the peak-to-peak time interval and can be measured by FPGA timers as the maximum and minimum voltage peaks are observed. In general ΔV increases with focusing ability of cell (i.e. dependent on the refractive index and size of the cell). ΔV reduces if the cell absorbs light. On the other hand, ΔS increases with cell radius. A state machine based on these two parameters can be implemented easily.

A scatter plot of ΔV vs. ΔS is shown in FIG. 55B. The data points indicate the clustering of different cell types around different parts of the plot. A scatter plot serves as an essential tool for determining the parameters that should be set when certain cells are targeted in the assay. Furthermore, the scatter plot can give a reference check as to whether certain parameters are correct. If the produced results do not match the scatter plot, then re-analysis may be performed to correct errors. Thus, the more accurate a scatter plot is, the more accurate the input parameters.

More parameters can be used to further distinguishing cell types, and different or multidimensional analyses can be made. Moreover, multi-segment detection (like that of FIG. 32D) scenarios naturally yield more parameters that can be used to distinguish cell types, and equivalent scatter plots can be used for display and analysis purposes.

A further extension that can be made is to specifically add dyes that attach to specific cell types, such that one of the parameters such as signal strength can change sufficiently to allow cells to be more easily distinguished.

Results

In experiments conducted by the applicant on beads using the present invention and a given set of threshold values, the results seen are not only accurate, but also reproducible. All beads of the same size and optical appearance are counted, and beads that are different than the normal beads are correctly discriminated. With the correct parameter settings, the same count is produced at different times, and on numerous occasions, the same count for a given group of beads is produced.

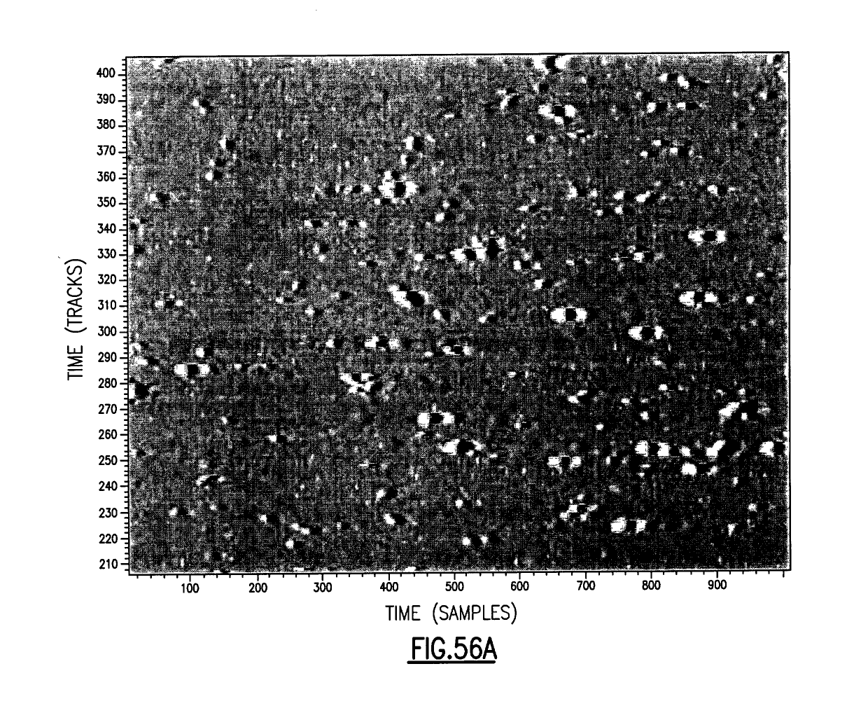

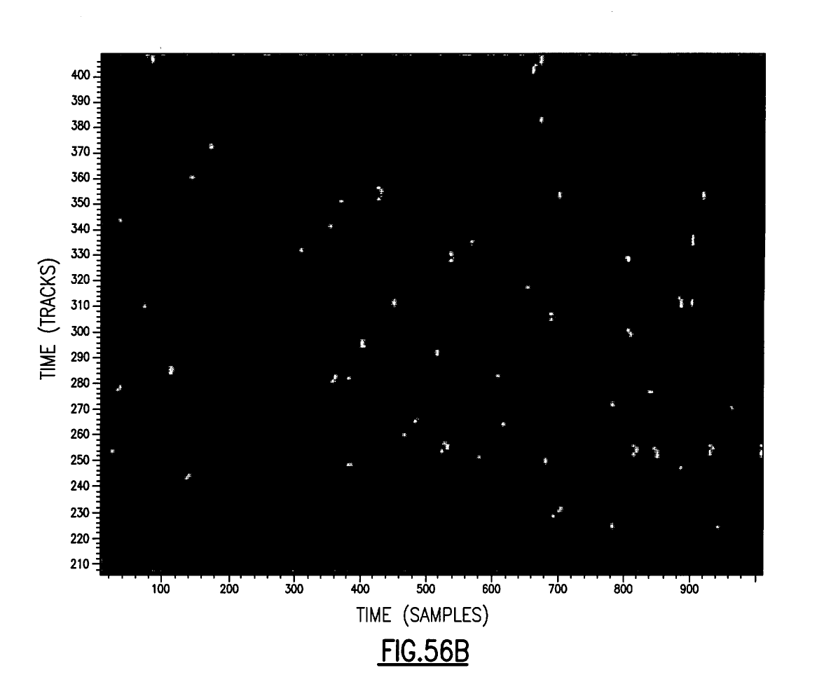

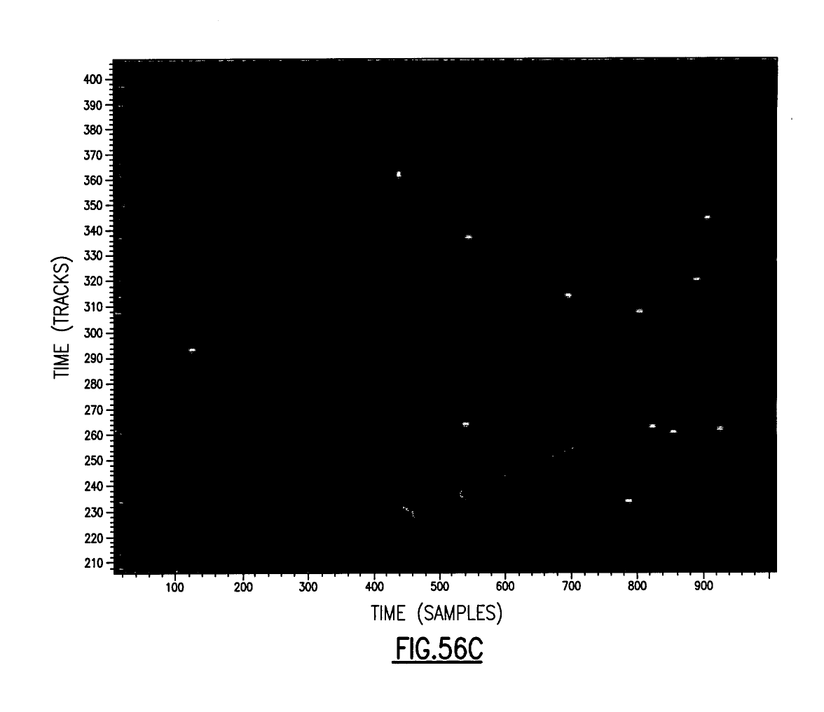

Testing and verifying the accuracy of counting was enabled through the following technique. The analog and digital outputs of the BCD Analyzer Controller (322 in FIG. 45) were used to provide signals that could be captured by an external, independent A/D converter system. The analog signal output carried the input signal to the level detector (336 in FIG. 47A). The first digital output carried trigger pulses indicating two different time windows. The first trigger pulse generated indicated the period during which S-Curves were being recognized. The second trigger pulse generated indicated the period during which correlation matrix processing was occurring. The second digital output carried digital pulses indicating two separate events. During the first trigger pulse, the second digital output pulses indicated when S-curves were recognized. During the second trigger pulse, the second digital output pulses indicated when cells were counted by the correlation matrix processing. An example analysis of white blood cell counting can be seen in FIGS. 56A-C. FIG. 56A is the analog output showing an image of the area counted. FIG. 56B is the digital output showing where S-curves were recognized. FIG. 56C is the digital output showing where cells where recognized.

Conclusion

Thus a method and apparatus for a segmented area detector for biodrive and component circuitry related to such a biodrive is described in conjunction with one or more specific embodiments. While this invention has been described in detail with reference to certain preferred embodiments, it should be appreciated that the present invention is not limited to those precise embodiments. Rather, in view of the present disclosure, which describes the current best mode for practicing the invention, many modifications and variations would present themselves to those of skill in the art without departing from the scope and spirit of this invention. The invention is defined by the claims and their full scope of equivalents.

We claim:

1. An optical biological disc analyzer comprising:
an optical bio-drive;
a controller placed inside said optical biological disc analyzer controlling said optical bio-drive; and
a field programmable gate array placed inside said controller.

2. The optical biological disc analyzer of claim 1 wherein said controller further comprises a split detector.

3. The optical biological disc analyzer of claim 1 wherein said controller further comprises:
a pre-amp component;
a channel selector;
an automatic gain control; and
a level detector.

4. The optical biological disc analyzer of claim 3 wherein said field programmable gate array further comprises:
a cell counting logic component;
an interface and control logic; and
an IDE controller logic for controlling said optical bio-drive.

5. The optical biological disc analyzer of claim 4 wherein said controller further comprises:
a transmissive trigger component;
a reflective trigger component;
and a triggering logic for using signals received from said transmissive trigger component or reflective trigger component to synchronize cell counting processing in said cell counting logic and said interface and control logic.

6. The optical biological disc analyzer of claim 1 wherein said controller further comprises:
a micro-controller;
an Ethernet controller;
a printer port; and
a plurality of memory components.

7. A method of counting cells in an optical biological disc analyzer comprising the steps of:
detecting a plurality of signals with a multi-segmented detector;
combining said plurality of signals into a resultant signal;
setting a plurality of thresholds to convert said resultant signal into a plurality of pulse trains; and
using a state machine counting process to detect the presence of signal data indicative of an investigational feature in said plurality of pulse trains.

8. The method of claim 7 wherein said multi-segmented detector has two segments.

9. The method of claim 8 wherein said step of combining further comprises taking the difference of the signals from said two segments.

10. The method of claim 9 wherein said plurality of thresholds comprise a positive and a negative threshold.

11. The method of claim 10 wherein said positive and negative thresholds are user-defined.

12. The method of claim 7 wherein said state machine is user-defined.

13. A detector utilized in utilized in an optical bio-drive comprising:
a plurality of segments.

14. The detector of claim 13 wherein the number of segments is 5.

15. The detector of claim 13 wherein the number of segments is 3, said segments comprising:
a left segment;
a right segment; and
a center segment.

16. The detector of claim 15 wherein said center segment further comprises two segments.

17. The detector of claim 13 wherein said segments are radially oriented.

18. The detector of claim 13 wherein said segments are tangentially oriented.

19. The detector of claim 13 wherein said segments are diagonally oriented.

20. The detector of claim 13 wherein said plurality of segments comprise:
a right segment; and
a left segment.

21. The detector of claim 20 wherein said right segment further comprises:
a short segment; and
a long segment.

22. The detector of claim 20 wherein said left segment further comprises:
a short segment; and
a long segment.

23. The detector of claim 13 wherein said detector is wider than the numerical aperture of the objective assembly in said optical bio-drive.

24. The detector of claim 13 wherein said detector is narrower than the numerical aperture of the objective assembly in said optical bio-drive.
